(19) United States
(12) Patent Application Publication
(10) Pub. No.: US 2018/0341901 A1
(43) Pub. Date: Nov. 29, 2018

(54) EVALUATION DEVICE, MANAGEMENT DEVICE, EVALUATION SYSTEM, AND EVALUATION METHOD

(71) Applicant: Komatsu Ltd., Tokyo (JP)

(72) Inventor: Chikashi Shike, Tokyo (JP)

(21) Appl. No.: 15/778,414

(22) PCT Filed: Feb. 22, 2017
(86) PCT No.: PCT/JP2017/006573

§ 371 Date: May 23, 2018

(30) Foreign Application Priority Data
Mar. 1, 2016 (JP) 2016-039416

(51) Int. Cl. G06Q 10/06; E02F 9/26; G06Q 50/08

(52) U.S. Cl. CPC G06Q 10/06398; G06Q 50/08; E02F 9/264

(57) ABSTRACT

An evaluation device incudes: a detected data acquisition unit to acquire detected data including the moving state of a work machine on the basis of movement data detected by a detector; an evaluation data generation unit to generate evaluation data of an operator on the basis of the detected data; a position data acquisition unit to acquire position data of the detector; a link processing unit to generate link data associating the evaluation data with the position data, and a link data output unit to output the link data.

### FIELD

The present invention relates to an evaluation device, a management device, an evaluation system, and an evaluation method.

### BACKGROUND

In selling or renting a work vehicle to a customer, a vendor or a rental dealer of the work vehicle can make appropriate proposal to the customer if skills of operators who operate the work vehicle are known. Patent Literature 1 discloses a technology for evaluating the skill level of an operator.

### CITATION LIST

### Patent Literature

Patent Literature 1: Japanese Laid-open Patent Publication No. 2009-235833 A

### SUMMARY

### Technical Problem

If the skill of an operator of the work vehicle and the location of the operator can be known, a vendor or a rental dealer of the work vehicle can efficiently carry out sales activities as follows. For example, in determining the order in which customers are to be visited, priorities can be given to visit to the locations of operators with poor skill, or the order of visits can be determined so that traveling for making rounds to destinations will be efficient. In addition, if the skill of an operator of the work vehicle and the location of the operator are known, a vendor or a rental dealer of the work vehicle can provide precise instruction of operation to operators belonging to the visited customer (a construction company, for example) depending on their skills. Furthermore, even if the skill of an operator is poor, a vendor or a rental dealer of the work vehicle can recommend a work vehicle called a computerized construction machine, which is capable of automatically controlling the work machine of the work vehicle, to a customer to help them finish a target construction.

Aspects of the present invention aim at providing an evaluation device, a management device, an evaluation system, and an evaluation method capable of evaluating the skill of an operator of a work vehicle and locating the operator.

### Solution to Problem

According to a first aspect of the present invention, an evaluation device comprises: a detected data acquisition unit configured to acquire detected data including a moving state of a work machine of a work vehicle operated by an operator through an operating device on the basis of movement data obtained by detecting operation of the work machine by a detector; an evaluation data generation unit configured to generate evaluation data of the operator on the basis of the detected data; a position data acquisition unit configured to acquire position data of the detector; a link processing unit configured to generate link data associating the evaluation data with the position data; and a link data output unit configured to output the link data.

According to a second aspect of the present invention, a management device comprises: a link data acquisition unit configured to acquire link data associating evaluation data of an operator generated on the basis of movement data, the movement data being obtained by detecting operation of a work machine of a work vehicle operated by the operator through an operating device by a detector, with position data of the detector; and a map data generation unit configured to extract a position of the operator from the link data to generate map data of the operator.

According to a third aspect of the present invention, an evaluation system comprises: a detected data acquisition unit configured to acquire detected data including a moving state of a work machine of a work vehicle operated by an operator through an operating device on the basis of movement data obtained by detecting operation of the work machine by a detector; an evaluation data generation unit configured to generate evaluation data of the operator on the basis of the detected data; a position data acquisition unit configured to acquire position data of the detector; a link processing unit configured to generate link data associating the evaluation data with the position data; and a link data acquisition unit configured to collect the link data of each of a plurality of operators.

According to a fourth aspect of the present invention, an evaluation method comprises: acquiring detected data including a moving state of a work machine of a work vehicle operated by an operator through an operating device on the basis of movement data obtained by detecting operation of the work machine by a detector; generating evaluation data of the operator on the basis of the detected data; acquiring position data of the detector; generating link data associating the evaluation data with the position data; and collecting the link data of each of a plurality of operators.

### Advantageous Effects of Invention

According to the aspects of the present invention, an evaluation device, a management device, an evaluation system, and an evaluation method capable of evaluating the skill of an operator of a work vehicle and locating the operator are provided.

### BRIEF DESCRIPTION OF DRAWINGS

FIG. 1 is a diagram schematically illustrating an example of an evaluation system according to the present embodiment.

FIG. 2 is a side view illustrating an example of an excavator according to the present embodiment.

FIG. 3 is a plan view illustrating the example of the excavator according to the present embodiment.

FIG. 4 is a diagram schematically illustrating an example of an operating device according to the present embodiment.

FIG. 5 is a diagram schematically illustrating an example of a hardware configuration of the evaluation system according to the present embodiment.

FIG. 6 is a functional block diagram illustrating an example of a portable device according to the present embodiment.

FIG. 7 is a functional block diagram illustrating an example of a management device according to the present embodiment.

FIG. 8 is a flowchart illustrating an example of an evaluation method according to the present embodiment.

FIG. 9 is a flowchart illustrating an example of a method for registering personal data according to the present embodiment.

FIG. 10 is a diagram for explaining an example of the method for registering personal data of an operator according to the present embodiment.

FIG. 11 is a diagram for explaining the example of the method for registering personal data of an operator according to the present embodiment.

FIG. 12 is a diagram for explaining the example of the method for registering personal data of an operator according to the present embodiment.

FIG. 13 is a diagram for explaining the example of the method for registering personal data of an operator according to the present embodiment.

FIG. 14 is a diagram for explaining the example of the method for registering personal data of an operator according to the present embodiment.

FIG. 15 is a diagram for explaining the example of the method for registering personal data of an operator according to the present embodiment.

FIG. 16 is a diagram for explaining an example of an imaging method according to the present embodiment.

FIG. 17 is a flowchart illustrating an example of imaging and evaluation methods according to the present embodiment.

FIG. 18 is a diagram for explaining a method for locating a movement end position of a work machine according to the present embodiment.

FIG. 19 is a diagram for explaining a method for generating target data representing a target movement locus of a work machine according to the present embodiment.

FIG. 20 is a diagram for explaining an example of a method for displaying relative data according to the present embodiment.

FIG. 21 is a diagram for explaining an example of a method for generating map data according to the present embodiment.

FIG. 22 is a diagram schematically illustrating an example of map data displayed on a display device according to the present embodiment.

FIG. 23 is a diagram schematically illustrating an example of map data displayed on a display device according to the present embodiment.

### DESCRIPTION OF EMBODIMENTS

An embodiment according to the present invention will be described below with reference to the drawings; the present invention, however, is not limited thereto. Components in each embodiment described below can be combined as appropriate. Furthermore, some of the components may not be used.

### Evaluation System

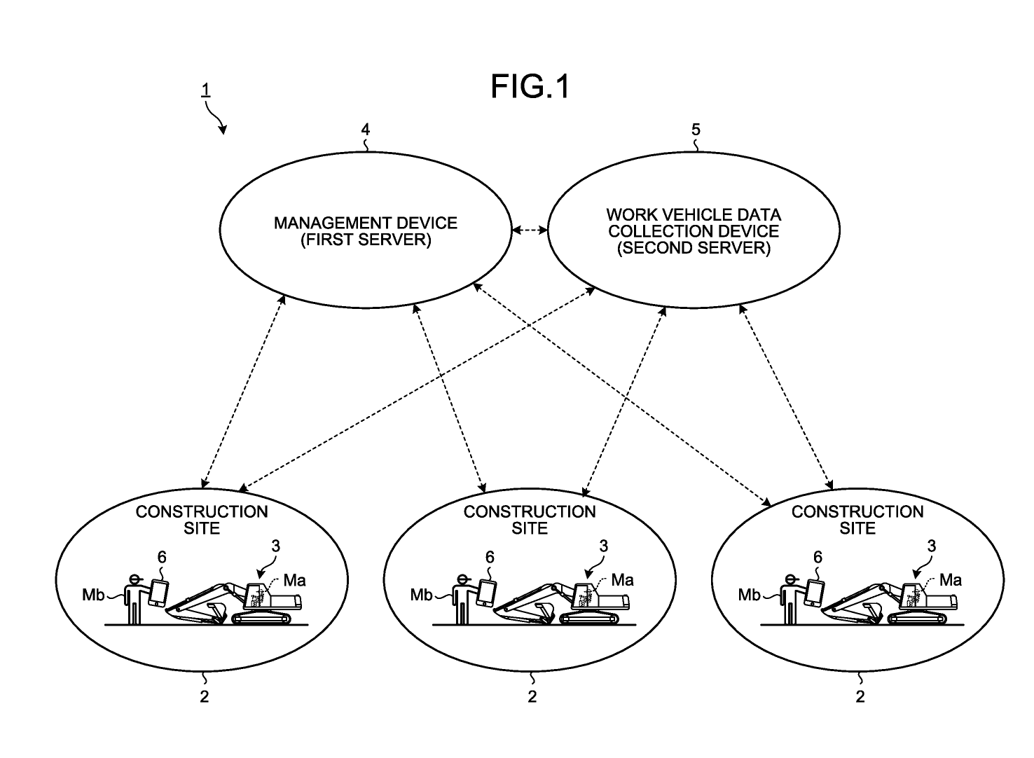

FIG. 1 is a diagram schematically illustrating an example of an evaluation system 1 according to the present embodiment. Work vehicles 3 operate at construction sites 2. A work vehicle 3 is operated by an operator Ma in the work vehicle 3. The evaluation system 1 performs one or both of evaluation of movement of a work vehicle 3 and evaluation of the skill of the operator Ma operating the work vehicle 3. The operator Ma carries out construction at a construction site by operating the work vehicle 3. A worker Mb other than the operator Ma works at the construction site 2. The worker Mb carries out supplementary work at the construction site 2, for example. The worker Mb uses a portable device 6, for example.

The evaluation system 1 includes a management device 4 including a computer system, a work vehicle data collection device 5 including a computer system, and the portable device 6 including a computer system. The management device 4 functions as a first server. The work vehicle data collection device 5 functions as a second server. The management device 4 and the work vehicle data collection device 5 provide services to customers including the user of the work vehicle 3 or the user of the portable device 6. The customers include at least one of the operator Ma, the worker Mb, the owner of the work vehicle 3, and a contractor who rents the work vehicle 3. Note that the owner of the work vehicle 3 and the operator Ma of the work vehicle 3 may be the same or different from each other.

The portable device 6 is held by at least one of the operator Ma and the worker Mb. Examples of the portable device 6 include a portable computer such as a smart phone or a tablet personal computer.

The management device 4 is capable of performing mutual data communication with a plurality of portable devices 6. The work vehicle data collection device 5 is capable of performing mutual data communication with a plurality of work vehicles 3.

### Work Vehicle

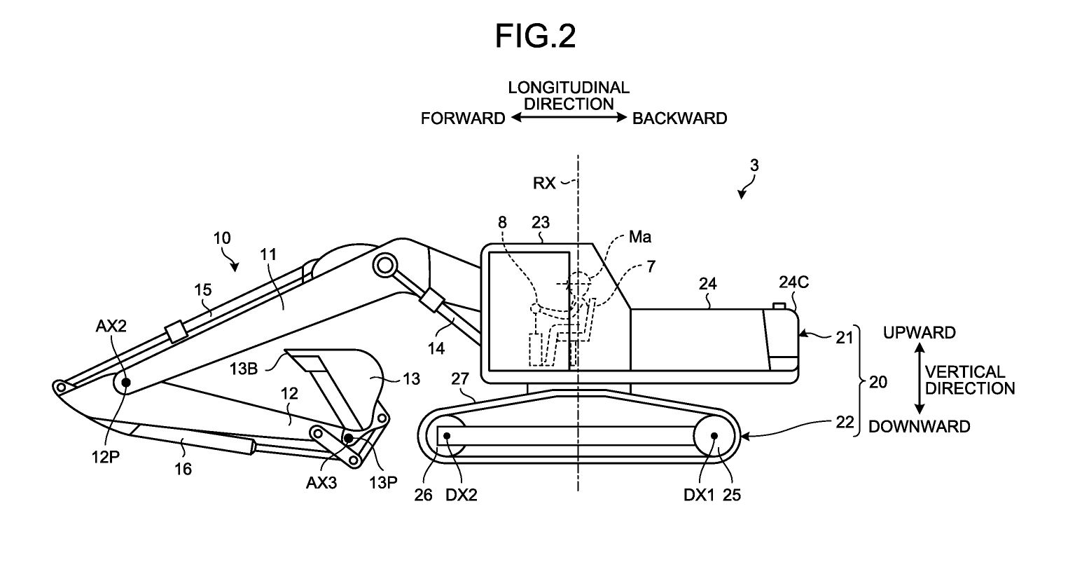

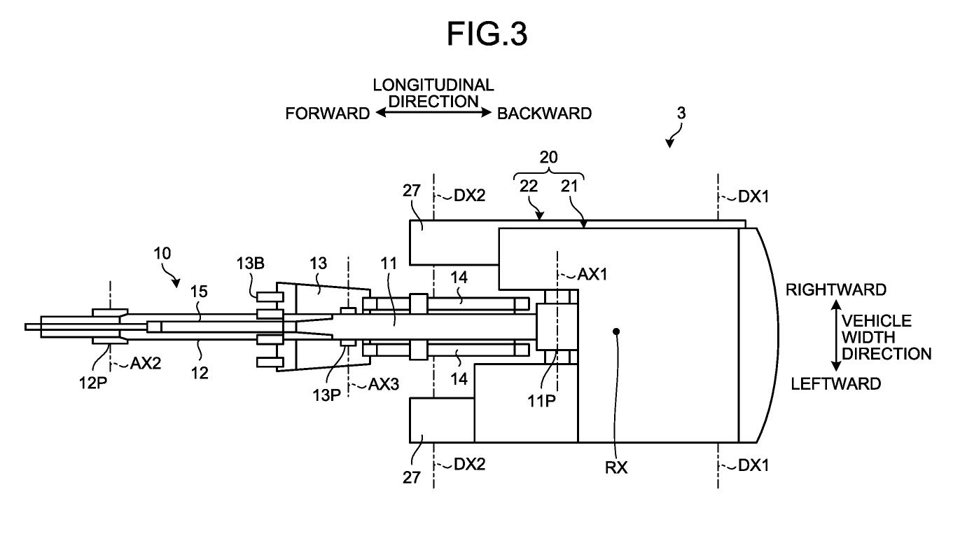

Next, a work vehicle 3 according to the present embodiment will be described. In the present embodiment, an example in which the work vehicle 3 is an excavator will be described. FIG. 2 is a side view illustrating an example of the excavator 3 according to the present embodiment. FIG. 3 is a plan view illustrating an example of the excavator 3 according to the present embodiment. Note that FIG. 3 illustrates a plan view of the excavator 3, with a work machine 10 being in a posture as in FIG. 2, as viewed from above.

As illustrated in FIGS. 2 and 3, the excavator 3 includes the hydraulically actuated work machine 10, and a vehicle body 20 supporting the work machine 10. The vehicle body 20 includes an upper swing structure 21, and a lower traveling structure 22 supporting the upper swing structure 21.

The upper swing structure 21 includes a cab 23, a machinery room 24, and a counter weight 24C. The cab 23 includes an operator's room. An operator's seat 7 on which the operator Ma sits and an operating device 8 operated by the operator Ma are disposed in the operator's room. The operating device 8 includes working levers for operating the work machine 10 and the upper swing structure 21, and traveling levers for operating the lower traveling structure 22. The work machine 10 is operated by the operator Ma via the operating device 8. The upper swing structure 21 and the lower traveling structure 22 are operated by the operator Ma via the operating device 8. The operator Ma is capable of operating the operating device 8 in a state seated on the operator's seat 7.

The lower traveling structure 21 has drive wheels 25 called sprockets, idler wheels 26 called idlers, and crawler tracks 27 supported by the drive wheels 25 and the idler wheels 26. The drive wheels 25 are actuated by power generated by a driving source such as a hydraulic pump. The drive wheels 25 rotate by operation of the traveling levers of the operating device 8. The drive wheels 25 each rotate about a rotation axis DX1. The idler wheels 26 each rotate about a rotation axis DX2. The rotation axis DX1 and the rotation axis DX2 are parallel to each other. The rotation of the drive wheels 25 and thus the rotation of the crawler tracks 27 causes the excavator 3 to travel forward or backward or swing.

The upper swing structure 21 is capable of swinging about a swing axis RX in a state in which the upper swing structure 21 is supported by the lower traveling structure 22.

The work machine 10 is supported by the upper swing structure 21 of the vehicle body 20. The work machine 10 includes a boom 11 coupled to the upper swing structure 21, an arm 12 coupled to the boom 11, and a bucket 13 coupled to the arm 12. The bucket 13 has a plurality of toothed blades. A plurality of blade edges 13B, which are end portions of the blades, are formed. Alternatively, the blade edges 13B of the bucket 13 may be end portions of straight blades provided on the bucket 13.

The upper swing structure 21 and the boom 11 are coupled to each other with a boom pin 11P. The boom 11 is supported by the upper swing structure 21 movably about a rotation axis AX1 being a fulcrum. The boom 11 and the arm 12 are coupled to each other with an arm pin 12P. The arm 12 is supported by the boom 11 movably about a rotation axis AX2 being a fulcrum. The arm 12 and the bucket 13 are coupled to each other with a bucket pin 13P. The bucket 13 is supported by the arm 12 movably about a rotation axis AX3 being a fulcrum. The rotation axis AX1, the rotation axis AX2, and the rotation axis AX3 are parallel to one another.

In the description below, a direction parallel to the rotation axes AX1, AX2, and AX3 will be referred to as a vehicle width direction of the upper swing structure 21 where appropriate, a direction parallel to the swing axis RX will be referred to as a vertical direction of the upper swing structure 21 where appropriate, and a direction perpendicular to both of the rotation axes AX1, AX2, and AX3 and the swing axis RX will be referred to as a longitudinal direction of the upper swing structure 21.

In the present embodiment, a direction in which the work machine 10 including the bucket 13 is present with respect to the operator Ma seated on the operator's seat 7 is a forward direction, and a direction opposite to the forward direction is a backward direction. One direction of the vehicle width direction is a rightward direction, and a direction opposite to the rightward direction, that is, a direction in which the cab 23 is present, is a leftward direction. The bucket 13 is positioned forward of the upper swing structure 21. The plurality of blade edges 13B of the bucket 13 are arranged in the vehicle width direction. The upper swing structure 21 is positioned above the lower traveling structure 22.

The work machine 10 is actuated by hydraulic cylinders. The excavator 3 has a boom cylinder 14 for actuating the boom 11, an arm cylinder 15 for actuating the arm 12, and a bucket cylinder 16 for actuating the bucket 13. Extension/contraction of the boom cylinder 14 causes the boom 11 to move about the rotation axis AX1 being a fulcrum, and a distal end of the boom 11 moves in the vertical direction. Extension/contraction of the arm cylinder 15 causes the arm 12 to move about the rotation axis AX2 being a fulcrum, and a distal end of the arm 12 moves in the vertical direction or the longitudinal direction. Extension/contraction of the bucket cylinder 16 causes the bucket 13 to move about the rotation axis AX3 being a fulcrum, and the blade edges 13B of the bucket 13 move in the vertical direction or the longitudinal direction. The hydraulic cylinders of the work machine 10 including the boom cylinder 14, the arm cylinder 15, and the bucket cylinder 16 are operated by the working levers of the operating device 8. The extension/contraction of the hydraulic cylinders of the work machine 10 changes the posture of the work machine 10.

### Operating Device

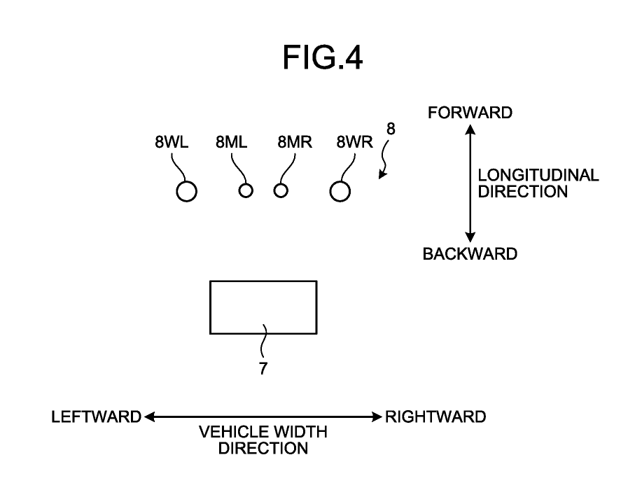

Next, the operating device 8 according to the present embodiment will be described. FIG. 4 is a diagram schematically illustrating an example of the operating device 8 according to the present embodiment. The working levers of the operating device 8 include a right working lever 8WR positioned rightward of the center of the operator's seat 7 in the vehicle width direction, and a left working lever 8WL positioned leftward of the center of the operator's seat 7 in the vehicle width direction. The traveling levers of the operating device 8 include a right traveling lever 8MR positioned rightward of the center of the operator's seat 7 in the vehicle width direction, and a left traveling lever 8ML positioned leftward of the center of the operator's seat 7 in the vehicle width direction.

Turning the right working lever 8WR at a neutral position forward causes the boom 11 to perform lowering movement, and turning the right working lever 8WR backward causes the boom 11 to perform lifting movement. Turning the right working lever 8WR at the neutral position rightward causes the bucket 13 to perform dumping movement, and turning the right working lever 8WR leftward causes the bucket 13 to perform digging movement.

Turning the left working lever 8WL at a neutral position rightward causes the upper swing structure 21 to swing rightward, and turning the left working lever 8WL leftward causes the upper swing structure 21 to swing leftward. Turning the left working lever 8WL at the neutral position downward causes the arm 12 to perform digging movement, and turning the left working lever upward causes the arm 12 to perform extending movement.

Turning the right traveling lever 8MR at a neutral position forward causes a right crawler 27 to perform forward movement, and turning the right traveling lever 8MR backward causes the right crawler 27 to perform backward movement. Turning the left traveling lever 8ML at a neutral position forward causes a left crawler 27 to perform forward movement, and turning the left traveling lever 8ML backward causes the left crawler 27 to perform backward movement.

Note that the operation pattern of the relations of movement between the turning directions of the right working lever 8WR and left working lever 8WL and the swing directions of the work machine 10 or the upper swing pair 21 need not correspond to the relations as described above.

### Hardware Configuration

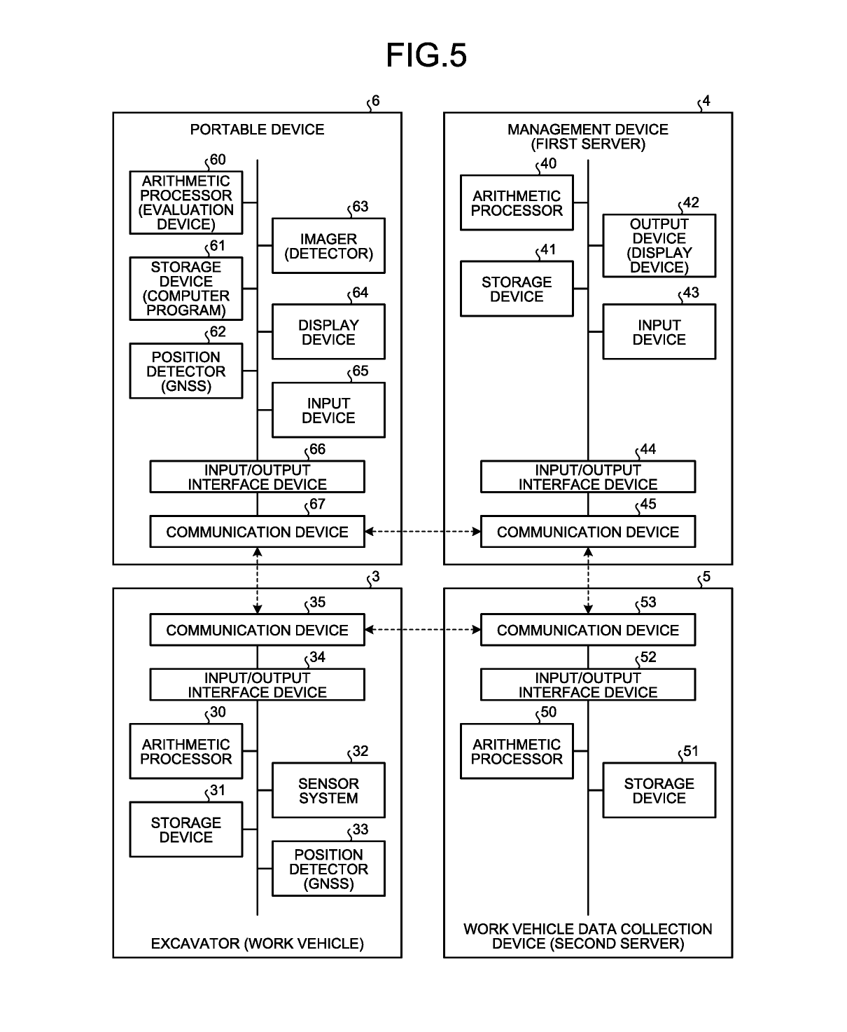

Next, a hardware configuration of the evaluation system 1 according to the present embodiment will be described. FIG. 5 is a diagram schematically illustrating an example of the hardware configuration of the evaluation system 1 according to the present embodiment.

The portable device 6 includes a computer system. The portable device 6 includes an arithmetic processor 60, a storage device 61, a position detector 62 to detect the position of the portable device 6, an imager 63, a display device 64, an input device 65, an input/output interface device 66, and a communication device 67.

The arithmetic processor 60 incudes a microprocessor such as a central processing unit (CPU). The storage device 61 includes a memory and a storage such as a read only memory (ROM) or a random access memory (RAM). The arithmetic processor 60 performs arithmetic processing according to a computer program stored in the storage device 61.

The position detector 62 detects an absolute position of the portable device 6, which is a position in a global coordinate system, by a global navigation satellite system (GNSS).

The imager 63 has a video camera function capable of acquiring moving image data of an object, and a still camera function capable of acquiring still image data of an object. The imager 63 includes an optical system and an image sensor to acquire imaging data of an object through the optical system. The image sensor includes a charge coupled device (CCD) image sensor or a complementary metal oxide semiconductor (CMOS) image sensor.

The imager 63 is capable of imaging the excavator 3. The imager 63 functions as a detector to detect movement data of the work machine 10 of the excavator 3. The imager 63 images the excavator 3 from outside of the excavator 3 to detect the movement of the work machine 10. The movement data are data obtained by detection of the movement of the work machine 10 of the excavator 3, which is operated by an operator via the operating device 8, by the imager 63. The imager 63 is capable of acquiring the imaging data of the work machine 10 to acquire movement data of the work machine 10 including at least one of the movement locus, the moving speed, and the movement time of the work machine 10. The imaging data of the work machine 10 include one or both of the moving image data and still image data of the work machine 10.

The display device 64 includes a flat panel display such as a liquid crystal display (LCD) or an organic electroluminescence display (OLED). The input device 65 is operated to generate input data. In the present embodiment, the input device 65 includes a touch sensor provided on a display screen of the display device 64. The display device 64 also includes a touch panel.

The input/output interface device 66 performs data communication with the arithmetic processor 60, the storage device 61, the position detector 62, the imager 63, the display device 64, the input device 65, and the communication device 67.

The communication device 67 performs wireless data communication with the management device 4. The communication device 67 performs data communication with the management device 4 by using a satellite communication network, a mobile communication network, or an Internet connection. Alternatively, the communication device 67 may perform data communication with the management device 4 via cables.

The excavator 3 has a computer system mounted thereon. The excavator 3 includes an arithmetic processor 30, a storage device 31, a sensor system 32, a position detector 33 to detect the position of the excavator 3, an input/output interface device 34, and a communication device 35.

The arithmetic processor 30 includes a microprocessor such as a CPU. The storage device 31 includes a memory and a storage such as a ROM or a RAM.

The sensor system 32 includes a plurality of sensors to detect work vehicle data of the excavator 3. The work vehicle data of the excavator 3 include use state data of the excavator 3. The sensor system 32 includes a moving speed sensor to detect the moving speed of the work machine 10, a traveling speed sensor to detect the traveling speed of the lower traveling structure 22, a fuel consumption sensor to detect the fuel consumption of the excavator 3, and a time sensor to detect the operating time of the excavator 3, for example.

The moving speed sensor to detect the moving speed of the work machine 10 includes a boom cylinder stroke sensor, an arm cylinder stroke sensor, and a bucket cylinder stroke sensor. The boom cylinder stroke sensor detects boom cylinder length data indicating the stroke length of the boom cylinder 14. The arm cylinder stroke sensor detects arm cylinder length data indicating the stroke length of the arm cylinder 15. The bucket cylinder stroke sensor detects bucket cylinder length data indicating the stroke length of the bucket cylinder 16. The moving speed data of the boom 11 are acquired on the basis of the change rate of the stroke length of the boom cylinder 14 per unit time detected by the boom cylinder stroke sensor. The moving speed data of the arm 12 are acquired on the basis of the change rate of the stroke length of the arm cylinder 15 per unit time detected by the arm cylinder stroke sensor. The moving speed data of the bucket 13 are acquired on the basis of the change rate of the stroke length of the bucket cylinder 16 per unit time detected by the bucket cylinder stroke sensor.

The position detector 33 detects an absolute position of the excavator 3, which is a position in a global coordinate system, by a global navigation satellite system (GNSS).

The input/output interface device 34 performs data communication with the arithmetic processor 30, the storage device 31, the sensor system 32, the position detector 33, and the communication device 35.

The communication device 35 performs wireless data communication with the work vehicle data collection device 5. The communication device 35 performs data communication with the work vehicle data collection device 5 by using a mobile communication network or an Internet connection.

The management device 4 includes a computer system. The management device 4 includes an arithmetic processor 40, a storage device 41, an output device 42, an input device 43, an input/output interface device 44, and a communication device 45.

The arithmetic processor 40 includes a microprocessor such as a CPU. The storage device 41 includes a memory and a storage such as a ROM or a RAM.

The output device 42 includes a display device such as a flat panel display. Note that the output device 42 may include a printer to output printed data. The input device 43 is operated to generate input data. The input device 43 includes at least one of a keyboard and a mouse. Note that the input device 43 may include a touch sensor provided on a display screen of the display device.

The input/output interface device 44 performs data communication with the arithmetic processor 40, the storage device 41, the output device 42, the input device 43, and the communication device 45.

The communication device 45 performs wireless data communication with the portable device 6. The communication device 45 performs data communication with the portable device 6 by using a mobile communication network or an Internet connection. The communication device 45 also performs data communication with the work vehicle data collection device 5 wirelessly or via cables.

The work vehicle data collection device 5 includes a computer system. The work vehicle data collection device 5 includes an arithmetic processor 50, a storage device 51, an input/output interface device 52, and a communication device 53.

The arithmetic processor 50 includes a microprocessor such as a CPU. The storage device 51 includes a memory and a storage such as a ROM or a RAM.

The input/output interface device 53 performs data communication with the arithmetic processor 50, the storage device 51, and the communication device 53.

The communication device 53 performs wireless data communication with the excavator 3. The communication device 53 performs data communication with the excavator 3 by using a mobile communication network or an Internet connection. The communication device 53 also performs data communication with the management device 4 wirelessly or via cables.

### Portable Device

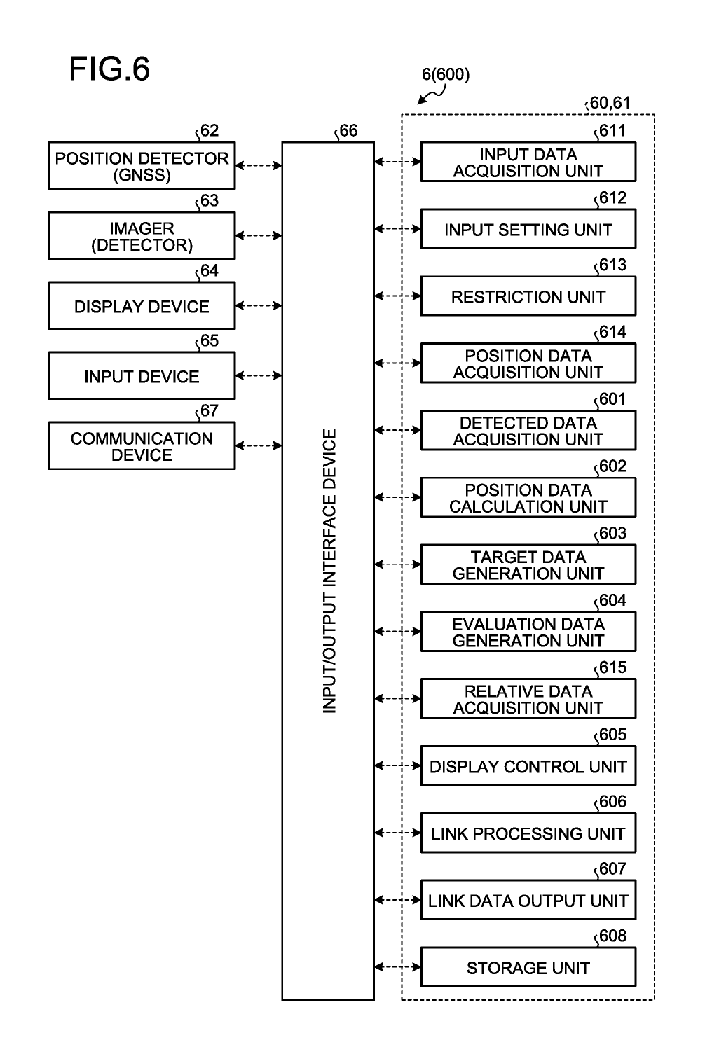

Next, the portable device 6 according to the present embodiment will be described. FIG. 6 is a functional block diagram illustrating an example of the portable device 6 according to the present embodiment. The portable device 6 functions as an evaluation device 600 that performs one or both of evaluation of the movement of the excavator 3 and evaluation of the skill of the operator Ma operating the excavator 3. The functions of the evaluation device 600 are achieved by the arithmetic processor 60 and the storage device 61.

The evaluation device 600 includes an input data acquisition unit 611 to acquire input data generated by operation of the input device 65, an input determination unit 612 to determine whether or not required data, which are prescribed input data, have been input, a restriction unit 613 to restrict the operation of the imager 63 when required data are determined not to have been input, a position data acquisition unit 614 to acquire position data of the imager 63, a detected data acquisition unit 601 to acquire detected data including the moving state of the work machine 10 of the excavator 3 on the basis of the movement data of the work machine 10 detected by the imager 63, a position data calculation unit 602 to calculate position data of the work machine 10 of the excavator 3 on the basis of the movement data of the work machine 10 detected by the imager 63, a target data generation unit 603 to generate target data including a target movement condition of the work machine 10, an evaluation data generation unit 604 to generate evaluation data on the basis of the detected data and the target data, a relative data acquisition unit 615 to acquire relative data representing evaluation of the operator Ma relative to other operators, a display control unit 605 to control the display device 64, a link data generation unit 606 to generate link data, a link data output unit 607 to output link data, a storage unit 608, and an input/output interface device 66. The evaluation device 600 performs data communication via the input/output interface device 66.

The imager 63 detects movement data of the work machine 10 from a movement start position to a movement end position operated by the operator Ma through the operating device 8. In the present embodiment, the movement data of the work machine 10 include imaging data of the work machine 10 obtained by imaging by the imager 63.

The input data acquisition unit 611 acquires input data generated on the basis of operation of the input device 65 of the portable device 6. In the present embodiment, the input data include personal data of the operator Ma. The personal data of the operator Ma include at least one of the sex, the age, and the number of years of experience of driving the excavator 3 of the operator Ma.

The input determination unit 612 determines whether or not required data, which are prescribed input data, have been input. In the present embodiment, the required data are the sex, the age, and the number of years of experience of driving the excavator 3 of the operator Ma, and the position data of the imager 65, for example. The required data include at least the position data of the imager 65. The input determination unit 612 determines whether or not the sex, the age, and the number of years of experience of driving the excavator 3 of the operator Ma, and the position data of the imager 65 have been input by operation of the input device 65.

The restriction unit 613 restricts the operation of the imager 63 when the required data are determined not to have been input. In the present embodiment, the restriction unit 613 restricts the operation of the operating device 63 so that imaging by the operating device 63 will not be performed when at least one of the sex, the age, and the number of years of experience of driving the excavator 3 of the operator Ma, and the position data of the imager 65 is determined not to have been input. The restriction unit 613 may determine that the required data have not been input when at least the position data of the imager 65 have not been input.

The position data acquisition unit 614 acquires position data representing an absolute position of the detector 63. The absolute position of the detector 63 is detected by the position detector 62. The position data acquisition unit 614 acquires the position data of the detector 63 from the position detector 62. Alternatively, the position data of the detector 63 may be input by the input device 65, and the position data acquisition unit 614 may acquire the position data of the detector 63 from the input device 65.

The detected data acquisition unit 601 acquires detected data including a movement locus of the work machine 10 from a movement start position to movement end position on the basis of the movement data of the work machine 10 from the movement start position to the movement end position detected by the imager 63.

The position data calculation unit 602 calculates position data of the work machine 10 from the movement data of the work machine 10 detected by the imager 63. The position data calculation unit 602 calculates the position data of the work machine 10 from the imaging data of the work machine 10 by using a pattern matching method, for example.

The target data generation unit 603 generates target data including a target movement locus of the work machine 10 from the movement data of the work machine 10 detected by the imager 63.

The evaluation data generation unit 604 generates evaluation data on the basis of the detected data acquired by the detected data acquisition unit 601 and the target data generated by the target data generation unit 602. The evaluation data include one or both of evaluation data on the movement of the work machine 10 and evaluation data on the operator Ma operating the work machine 10 through the operating device 8.

The relative data acquisition unit 615 acquires relative data representing evaluation of the operator Ma relative to other operators Ma. In the present embodiment, the relative data representing evaluation of the operator Ma relative to other operators Ma include ranking data of the skills of a plurality of operators Ma.

The display control unit 605 generates display data from the detected data and the target data, and displays the display data on the display device 64. The display control unit 605 also generates display data from the evaluation data, and displays the display data on the display device 64. The display control unit 605 also generates display data from the relative data, and displays the display data on the display device 64.

The link processing unit 606 generates link data associating the evaluation data of the operator Ma with the position data of the imager 63. The link processing unit 606 generates the link data by associating the evaluation data of the operator Ma generated by the evaluation data generation unit 604 with the position data of the imager 63 detected by the position detector 62. Alternatively, the link processing unit 606 may generate link data associating the evaluation data of the operator Ma, the position data of the imager 63, the personal data of the operator Ma, and the relative data of the operator Ma with one another. Thus, in the present embodiment, the link data include the evaluation data of the operator Ma, the personal data of the operator Ma, the relative data of the operator Ma, and the position data of the imager 63 representing the position at which the evaluation of the operator Ma is performed. The link data are output by the link data output unit 607.

The storage unit 608 stores various data. The storage unit 608 also stores computer programs for carrying out an evaluation method according to the present embodiment.

### Management Device

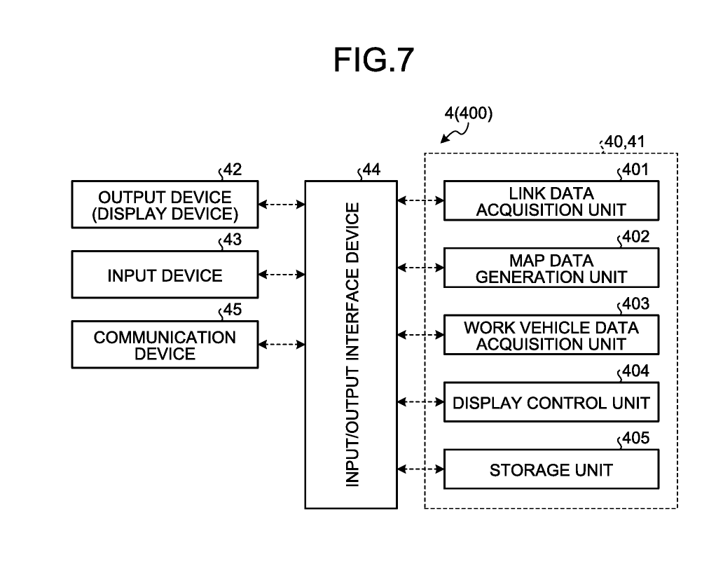

Next, the management device 4 according to the present embodiment will be described. FIG. 7 is a functional block diagram illustrating an example of the management device 4 according to the present embodiment. The management device 4 functions as an evaluation device 400 that performs one or both of evaluation of the movement of the excavator 3 and evaluation of the skill of the operator Ma operating the excavator 3. The functions of the evaluation device 400 are achieved by the arithmetic processor 40 and the storage device 41.

The evaluation device 400 includes a link data acquisition unit 401 to acquire link data generated by the link processing unit 606 of the portable device 6 and transmitted from the link data output unit 607 via the communication device 67, a map data generation unit 402 to extract the position of the operator Ma from the link data and generate map data of the operator Ma, a work vehicle data acquisition unit 403 to acquire work vehicle data, which represent the position and the use state of the excavator 3 detected by the detector 63, from the work vehicle data collection device 5, a display control unit 404 to generate display data from the map data and display the display data on the display device 42, a storage unit 405, and an input/output interface device 44.

The link data acquisition unit 401 acquires the link data associating the evaluation data of the operator Ma with the position data of the imager 63, which are generated on the basis of the movement data of the work machine 10 of the excavator 3 operated by the operator Ma through the operating device 8 and detected by the imager 63, from the portable device 6. The link data acquisition unit 401 collects link data of each of a plurality of operators Ma from a plurality of portable devices 6 present all over the country.

The map data generation unit 402 extracts the position of an operator Ma from the link data acquired by the link data acquisition unit 401, and generates map data of the operator Ma. The map data generation unit 402 extracts the positions of a plurality of operators Ma present all over the country from link data of each of the plurality of operators Ma, and generates map data of the operators Ma. In the present embodiment, the map data include the position data of the operators Ma, the evaluation data of the operators Ma, the personal data of the operators Ma, and the relative data of the operators Ma. In the present embodiment, the position data of an operator Ma are the position data of the imager 63 used for evaluation of the operator Ma.

The work vehicle data acquisition unit 403 acquires work vehicle data representing the absolute position and the use state of the excavator 3 having the work machine 10 operated by an operator Ma. The absolute position of the excavator 3 is detected by the position detector 33. The use state of the excavator 3 is detected by the sensor system 32. The detected data from the position detector 33 and the detected data from the sensor system 32 are transmitted to the work vehicle data collection device 5 via the communication device 35. The work vehicle data collection device 5 transmits the work vehicle data representing the absolute position and the use state of the excavator 3 to the management device 4 via the communication device 53. The work vehicle data acquisition unit 403 acquires the work vehicle data from the work vehicle data collection device 5.

In the present embodiment, the absolute position of the excavator 3, the absolute position of the imager 63 that has imaged the excavator 3, and the position of the operator Ma that has operated the excavator 3 can be deemed to be substantially the same. Time data, which represent a time point Ta at which link data are generated on the basis of the movement data of the work machine 10 acquired by the imager 63, are also transmitted together with the link data to the link data acquisition unit 401 from the portable device 6. In addition, the work vehicle data including the position data of the excavator 3 are also transmitted at regular time intervals to the work vehicle data collection device 5 from the excavator 3. The link data acquisition unit 401 is capable of associating an excavator 3 operated by an operator Ma at a time point Ta at which link data are generated with the imager 63 that has acquired the movement data of the work machine 10 of the excavator 3 on the basis of the position of the imager 63 extracted from the link data, the position of the excavator 3 extracted from work vehicle data, and the time point Ta. Thus, the link data acquisition unit 401 is capable of identifying the location of the imager 63 that has acquired the movement data of an excavator 3 from among a plurality of imagers 63 and a plurality of excavators 3 present all over the country on the basis of the position of the imager 63 at the time point Ta extracted from the link data and the position of the excavator 3 at the time point Ta extracted from the work vehicle data.

The map data generation unit 402 extracts the position and the use state of each excavator 3 from work vehicle data, and generates map data of excavators 3. The map data generation unit 402 is capable of generating map data indicating the location and the skill level of the operator Ma who has operated an excavator 3 and the use state of the excavator 3 among a plurality of operators Ma and a plurality of excavators 3 present all over the country.

The storage unit 405 stores various data. The storage unit 608 also stores computer programs for carrying out an evaluation method according to the present embodiment.

### Evaluation Method

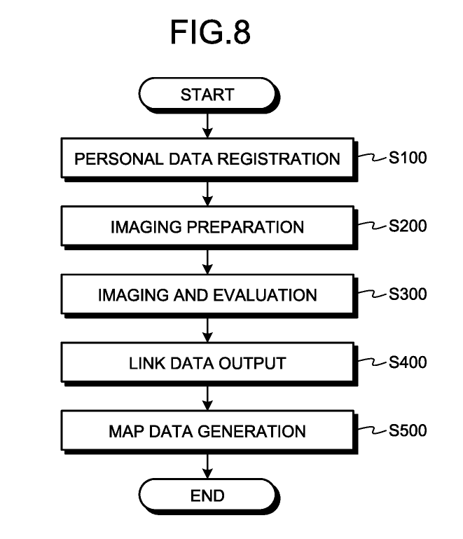

Next, a method for evaluating an operator Ma according to the present embodiment will be described. FIG. 8 is a flowchart illustrating an example of the evaluation method according to the present embodiment.

In the present embodiment, the evaluation method includes a step (S100) of registering the personal data of the operator Ma by using a portable device 6, a step (S200) of preparing for imaging of an excavator 3 by an imager 63, a step (S300) imaging the excavator 3 by using the imager 63 and evaluating the operator Ma, a step (S400) of generating and outputting link data, and a step (S500) pf generating map data of the operator Ma.

### Personal Data Registration

For evaluation of the skill of an operator Ma operating an excavator 3, the personal data of the operator Ma are registered (step S100).

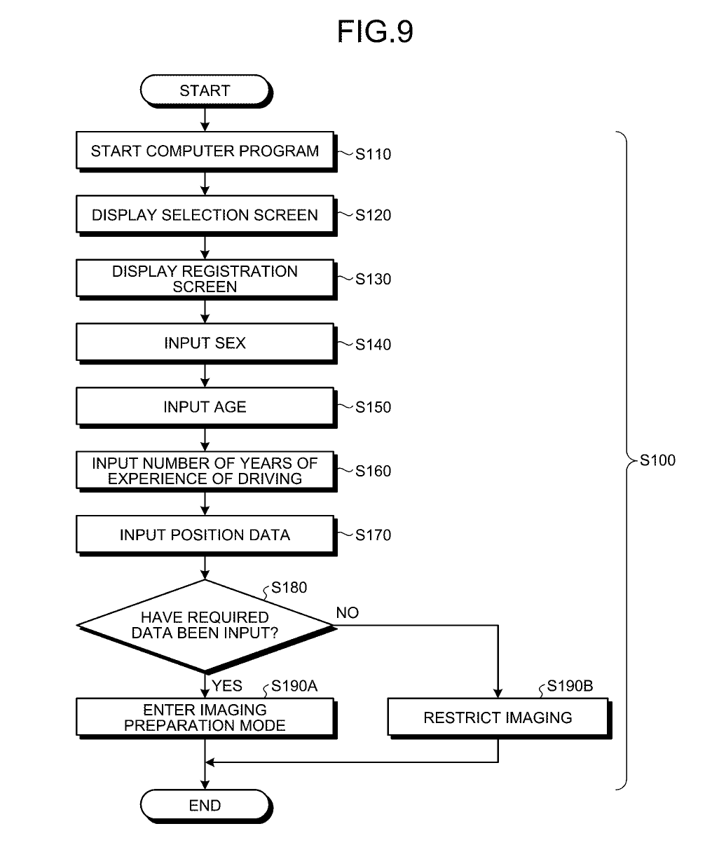

FIG. 9 is a flowchart illustrating an example of the method for registering personal data of an operator Ma according to the present embodiment. In the present embodiment, the method for registering personal data includes a step (S110) of operating the input device 65 of the portable device 6 to start a computer program stored in the storage unit 608, a step (S120) of displaying a selection screen on the display device 64 of the portable device 6, a step (S130) of displaying a registration screen on the display device 64 of the portable device 6, a step (S140) of inputting the sex of the operator Ma, a step (S150) of inputting the age of the operator Ma, a step (S160) of inputting the number of years of experience of driving the excavator 3 of the operator Ma, a step (S170) of inputting the position data of the imager 63, a step (S180) of determining whether or not the required data have been input, a step (S190A) of entering an imaging preparation mode depending on the determination in step S180, and a step (S190B) of restricting the imaging by the imager 63 depending on the determination in step S180. Note that the order in which the required data are input in steps S140 to S170 is not limited to such an order.

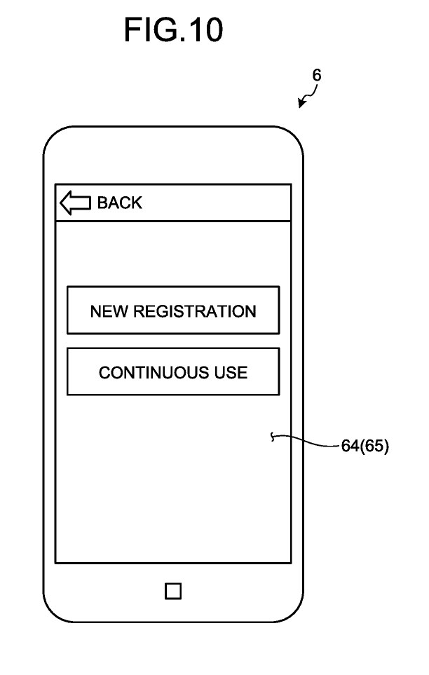

FIGS. 10 to 15 are diagrams for explaining an example of the method for registering personal data of an operator Ma according to the present embodiment.

A computer program stored in the storage unit 608 is started by operation of the input device 65 of the portable device 6 by an operator Ma or a worker Mb. The start of the computer program causes the portable device 6 to enter a personal data registration mode. When the portable device 6 enters the personal data registration mode, display data representing start of registration of the personal data of the operator Ma are displayed on the display device 64 of the portable device 6 (step S100).

FIG. 10 illustrates example display of the display device 64 of the portable device 6 in the personal data registration mode. When the personal data registration mode is started, display data for selecting whether or not the operator Ma is to be newly registered or is already registered are displayed on the display device 64 of the portable device 6 as illustrated in FIG. 10 (step S120). If the operator Ma is to be newly registered, “NEW REGISTRATION” is selected. If the registration data of the operator Ma are already registered, “CONTINUOUS USE” is selected. The operator Ma or the worker Mb operates the touch sensor provide on the display screen of the display device 64 of the portable device 6 to select either one of “NEW REGISTRATION” and “CONTINUOUS USE.”

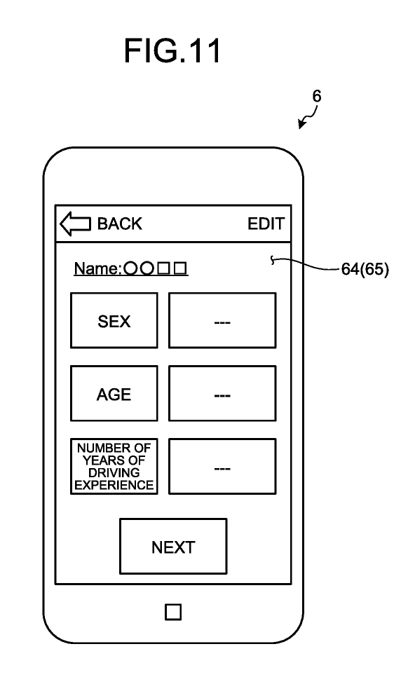

FIG. 11 illustrates example display of the display device 64 of the portable device 6 when “NEW REGISTRATION” illustrated in FIG. 10 is selected. When “NEW REGISTRATION” is selected, display data for registering the personal data of the operator Ma are displayed on the display device 64 of the portable device 6 as illustrated in FIG. 11 (step S130).

In the present embodiment, the personal data of the operator Ma include at least one of the sex, the age, and the number of years of experience of driving the excavator 3 of the operator Ma. The operator Ma or the worker Mb operates the touch screen provided on the display screen of the display device 64 of the portable device 6 to input the sex, the age, and the number of years of experience of driving the excavator 3 of the operator Ma. Note that the name, an abbreviated name, or the like may also be input together with the personal data. The input name or the like may be displayed on the display screen of the display device 64.

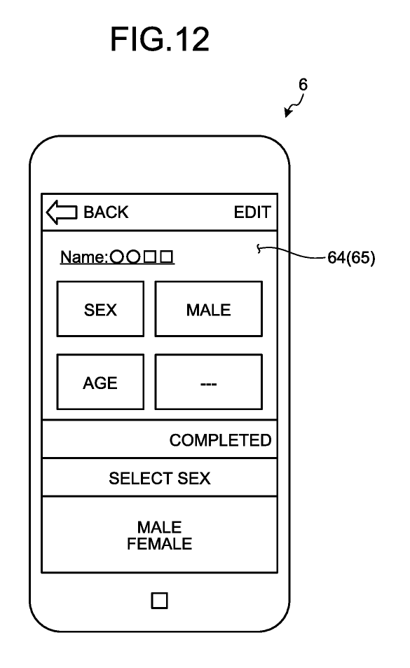

FIG. 12 illustrates example display of the display device 64 when display data for registering the “sex” of the operator Ma are displayed on the display device 64 of the portable device 6 and the “sex” is input (step S140). The input “sex” of the operator Ma is held in the storage unit 608.

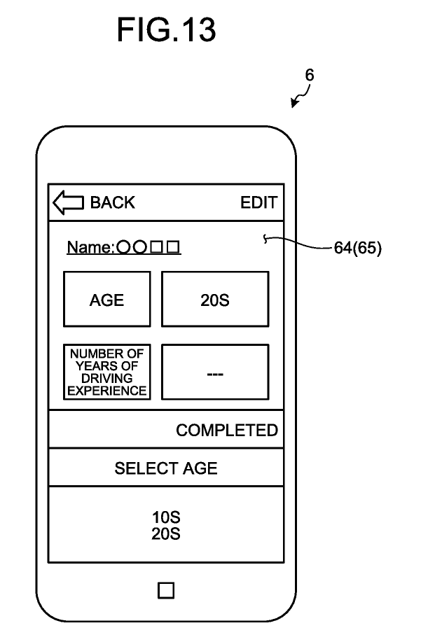

FIG. 13 illustrates example display of the display device 64 when display data for registering the “age” of the operator Ma are displayed on the display device 64 of the portable device 6 and the “age” is input (step S150). Alternatively, an “age group” may be selected and input as in FIG. 13 instead of the “age” being input. The input “age” of the operator Ma is held in the storage unit 608.

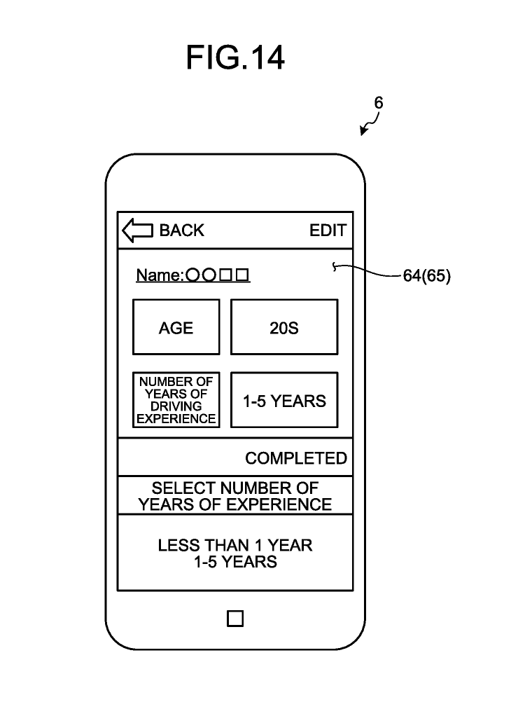

FIG. 14 illustrates example display of the display device 64 when display data for registering the “number of years of experience of driving” the excavator 3 of the operator Ma are displayed on the display device 64 of the portable device 6, and the “number of years of driving experience” is input (step S160). Note that the input “number of years of driving experience” may be a numerical value indicating the number of years of driving experience, or a classification indicating a range of the number of years of driving experience may be selected and input as illustrated in FIG. 14. The input “number of years of driving experience” of the operator Ma is held in the storage unit 608.

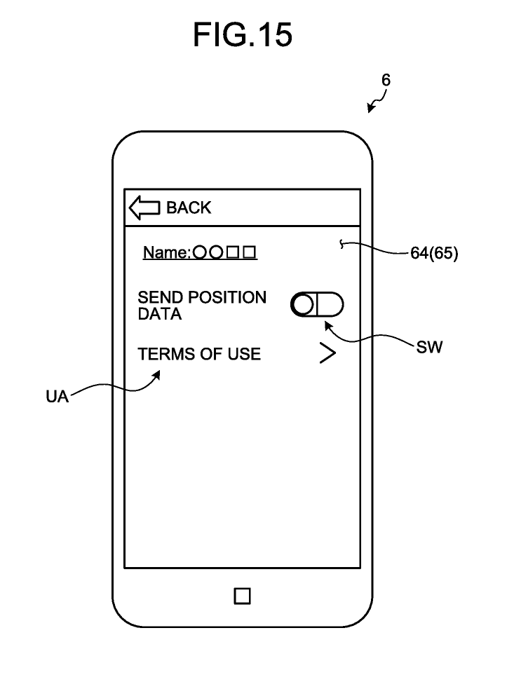

When the personal data including the sex, the age, and the number of years of experience of driving the excavator 3 of the operator Ma are input, display data for inputting the position data of the imager 63 of the portable device 6 are displayed on the display device 64 of the portable device 6 as illustrated in FIG. 15. In the present embodiment, a switch SW for selecting whether or not to register the position data of the imager 63 is displayed on the display device 64 (step S170). Note that, in the example illustrated in FIG. 15, information UA such as “terms of use” is displayed on the display device 64. When operation of the switch SW indicating that the position data of the imager 63 is to be registered, the position data acquisition unit 614 acquires the position data of the imager 63, and link data associating the evaluation data of the operator Ma with the position data of the imager 63 are generated by the link processing unit 606.

The input determination unit 612 determines whether or not required data, which are prescribed input data, have been input (step S180). The required data are the sex, the age, and the number of years of experience of driving the excavator 3 of the operator Ma, and the position data of the imager 65. The input determination unit 612 determines whether or not the sex, the age, and the number of years of experience of driving the excavator 3 of the operator Ma, and the position data of the imager 65 have been input by operation of the input device 65.

If the required data are determined to have been input in step S180 (step S180: Yes), the portable device 6 enters the imaging preparation mode (step S190A).

If the required data are determined not to have been input in step S180 (step S180: No), the restriction unit 613 restricts the operation of the imager 63 (step S190B). In the present embodiment, when at least one of the sex, the age, and the number of years of experience of driving the excavator 3 of the operator Ma, and the position data of the imager 65 is determined not to have been input, the restriction unit 613 restricts the operation of the imager 63 so that imaging by the operating device 63 will not be performed. Thus, in the present embodiment, for evaluation of the operator Ma with the evaluation device 600, registration of the sex, the age, and the number of years of experience of driving the excavator 3 of the operator Ma, and the position data of the imager 65 is required, and the evaluation of the operator Ma with the evaluation device 600 is not performed unless the required data have been input. Alternatively, the operation of the imager 63 may be restricted only when the position data among the required data have not been input. Still alternatively, evaluation of the operator Ma by the evaluation device 600 may also not be performed when the display data of the “terms of use UA” are displayed as illustrated in FIG. 15 and operation of a button, which is not illustrated, indicating acceptance the “terms of use UA” is not performed by the operator Ma or the worker Mb.

### Imaging Preparation

After the personal data of the operator Ma are registered, preparation for imaging the excavator 3 by the imager 63 is carried out (step S200).

For making the condition for imaging the excavator 3 constant, a process of determining relative positions of the excavator 3 and the imager 63 that images the excavator 3 is performed.

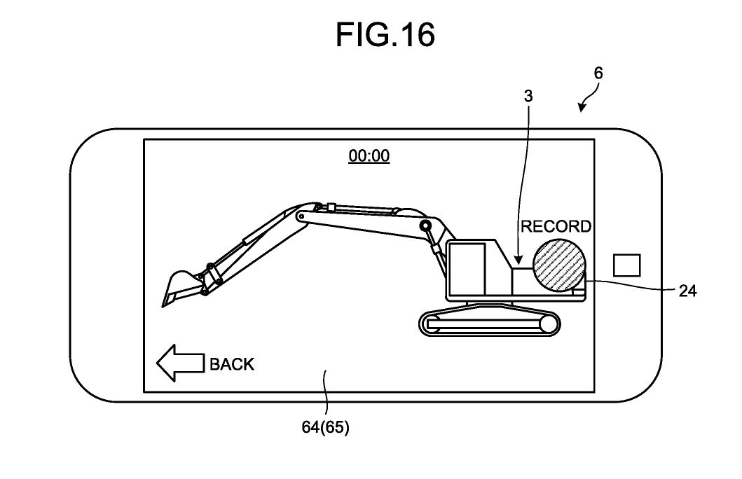

FIG. 16 is a diagram for explaining an example of an imaging method according to the present embodiment. When registration of the personal data of the operator Ma is completed, the portable device 6 enters the imaging preparation mode. In the imaging preparation mode, a zoom function of the imager 63 is limited. The excavator 3 is imaged by the imager 63 with a fixed preset imaging magnification.

After the imaging position is determined, a process of locating the position of the upper swing structure 21 is performed. The position data calculation unit 602 locates the position of the upper swing structure 21 by using the pattern matching method. After the position of the upper swing structure 21 is located, the position data calculation unit 602 locates the work machine 10. The location of the position of the work machine 10 includes location of the position of the blade edges 13B of the bucket 13.

### Imaging and Evaluation

After the position of the work machine 10 is located, the portable device 6 enters an imaging and evaluation mode.

In the imaging and evaluation mode as well, the zoom function of the optical system of the imager 63 is limited. The excavator 3 is imaged by the imager 63 with a fixed preset imaging magnification. The preset imaging magnification in the imaging preparation mode and the preset imaging magnification in the imaging and evaluation mode are equal.

A state of movement of the work machine 10 of the excavator 3, which is operated by the operator Ma via the operating device 8, is imaged by the imager 63 of the portable device 6. In the present embodiment, an operating condition of the work machine 10 operated by the operator Ma for evaluation of the operator Ma is determined such that the work machine 10 moves under a specific movement condition.

In the present embodiment, an operating condition of operating the work machine 10 in such a manner that the blade edges 13B of the bucket 13 in an unloaded state in the air follow a linear movement locus along a horizontal plane is imposed on the operator Ma. The operator Ma operates the operating device 8 so that the blade edges 13B of the bucket 13 follow a linear movement locus along a horizontal plane. The worker Mb images the excavator 3 from outside of the excavator 3.

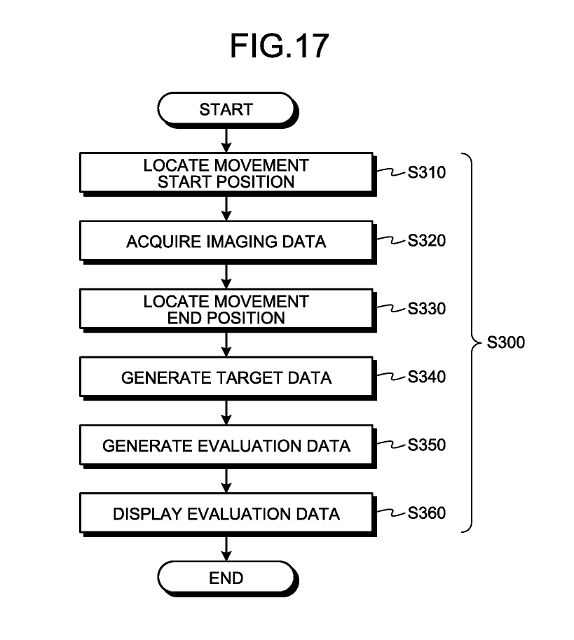

FIG. 17 is a flowchart illustrating an example of imaging and evaluation methods according to the present embodiment. The imaging and evaluation methods according to the present embodiment include a step (S310) of locating a movement start position of the work machine 10, a step (S320) of acquiring imaging data of the moving work machine 10, a step (S330) of locating a movement end position of the work machine 10, a step (S340) of generating target data of the work machine 10, a step (S350) of generating evaluation data of the operator Ma on the basis of the imaging data and the target data, and a step (S360) of displaying the evaluation data on the display device 64.

A process of locating the movement start position and determining a movement start time point of the bucket 13 of the work machine 10 is performed (step S310). The detected data acquisition unit 601 locates the position of the blade edges 133 of the bucket 13 of the work machine 10 in a stationary state on the basis of the imaging data of the work machine 10 imaged by the imager 63. When the time for which the blade edges 13B of the bucket 13 remain stationary is determined to be equal to or longer than a preset time, the detected data acquisition unit 601 determines the position of the blade edges 13B of the bucket 13 to be a movement start position SP of the bucket 13.

When the bucket 13 in the stationary state starts moving by the operation of the operator Ma, the detected data acquisition unit 601 detects that the movement of the bucket 13 is started on the basis of the imaging data of the work machine 10. The detected data acquisition unit 601 determines the time point when the blade edges 13B of the bucket 13 in the stationary state starts moving to be the movement start time point of the bucket 13.

When the movement of the bucket 13 is started, the detected data acquisition unit 601 acquires the imaging data, which are moving image data of the work machine 10, from the imager 63 (step S320).

In the present embodiment, the detected data acquisition unit 601 acquires detected data including the movement locus of the work machine 10 on the basis of the imaging data of the bucket 13 from the movement start position to the movement end position. In the present embodiment, the detected data include the movement locus of the work machine 10 in an unloaded state in the air from when the work machine 10 in the stationary state starts moving at the movement start position to when the work machine 10 terminates moving at the movement end position. The detected data acquisition unit 601 acquires the movement locus of the bucket 13 on the basis of the imaging data. The detected data acquisition unit 601 also acquires the time having elapsed from when the bucket 13 started moving on the basis of the imaging data.

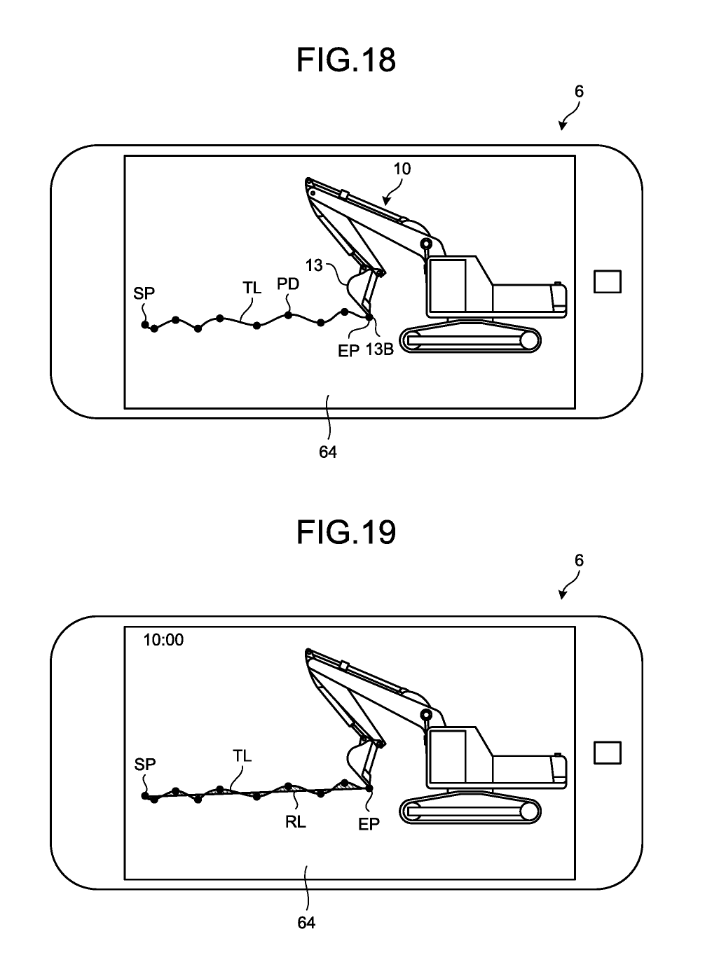

FIG. 18 illustrates the display device 64 displaying the movement locus of the bucket 3. When the movement of the bucket 13 is determined to have been started by the detected data acquisition unit 601, the display control unit 605 displays display data representing the blade edges 13P of the bucket 13 on the display device 64. In the present embodiment, the display control unit 605 displays a plot PD, which is display data representing the blade edges 13P, on the display device 64.

The detected data acquisition unit 601 continues to calculate position data of the bucket 13 on the basis of the imaging data, and acquires the movement locus of the blade edges 13B of the bucket 13. The detected data acquisition unit 601 also acquires an elapsed time indicating the movement time of the bucket 13 from the movement start time point.

The display control unit 605 generates display data representing the movement locus of the bucket 13 from the detected data, and displays the display data on the display device 64. The display control unit 605 generates a plot PD representing the position of the blade edges 13B of the bucket 13 on the basis of the detected data at regular time intervals. The display control unit 605 displays the plots PD generated at regular time intervals on the display device 64. In FIG. 18, short intervals of the plots PD indicate that the moving speed of the bucket 13 is low, and long intervals of the plots PD indicate that the moving speed of the bucket 13 is high.

The display control unit 605 also displays a detected line TL representing the movement locus of the bucket 13 on the basis of a plurality of plots PD on the display device 64. The detected line TL is curved display data connecting the plurality of plots PD.

When the bucket 13 in a moving state stops moving as a result of operation of the operator Ma, a process of locating the movement end position and determining a movement end time point of the bucket 13 of the work machine 10 is performed (step S330).

When the bucket 13 in the moving state has stopped moving as a result of operation of the operator Ma, the detected data acquisition unit 601 detects that the movement of the bucket 13 is stopped on the basis of the imaging data. The detected data acquisition unit 601 determines the position at which the blade edges 13B of the bucket 13 in the moving state has stopped moving to be a movement end position EP of the bucket 13. The detected data acquisition unit 601 also determines the time point when the blade edges 13B of the bucket 13 in the moving state stops moving to be movement end time point of the bucket 13. When the bucket 13 in the moving state stops moving and the time for which the blade edges 13B of the bucket 13 remain stationary is determined to be equal to or longer than a preset time, the detected data acquisition unit 601 determines the position of the blade edges 13B of the bucket 13 to be the movement end position of the bucket 13.

After the movement of the work machine 10 is stopped, a process of generating target data representing a target movement locus of the work machine 10 is performed (step S340). FIG. 19 is a diagram for explaining a method for generating the target data representing the target movement locus of the work machine 10 according to the present embodiment. The target data generation unit 603 generates the target data representing the target movement locus of the bucket 13.

In the present embodiment, the target movement locus includes a straight line connecting the movement start position SP with the movement end position EP.

As illustrated in FIG. 19, the display control unit 605 generates display data to be displayed on the display device 64 from the target data, and displays the display data on the display device 64. In the present embodiment, the display control unit 605 displays a target line RL representing a target movement locus connecting the movement start position SP with the movement end position EP on the display device 64. The target line RL is linear display data connecting the movement start position SP with the movement end position EP.

The display control unit 605 also displays the plots PD and the detected line TL together with the target line RL on the display device 64. As described above, the display control unit 605 generates display data including the plots PD and the detected line TL from the detected data, generates display data including the target line RL from the target data, and displays the display data on the display device 64.

Display of the detected line TL and the target line RL on the display device 64 at the same time allows the worker Mb or the operator Ma to recognize how far the actual movement locus of the bucket 13 is from the target movement locus represented by the straight line.

After the detected data including the movement locus are acquired and the target data including the target movement locus are generated, a process of generating the evaluation data of the operator Ma on the basis of the detected data and the target data is performed (step S350).

The evaluation data generation unit 604 generates the evaluation data of the operator Ma on the basis of the difference between the movement locus and the target movement locus. As the difference between the detected movement locus and the target movement locus is small, which means that the bucket 13 was able to be moved more along the target movement locus, the skill of the operator Ma is evaluated to be higher. In contrast, as the difference between the movement locus and the target movement locus, which means that the bucket 13 as able to be moved less along the target movement locus, the skill of the operator Ma is evaluated to be lower.

In the present embodiment, the evaluation data generation unit generates the evaluation data on the basis of an area of a plane defined by the detected line TL representing the movement locus and the target line RL representing the target movement locus. Specifically, as illustrated by hatching in FIG. 19, the area of the plane defined by the detected line TL mainly represented by a curve and the target line RL represented by a straight line is calculated, and the evaluation data are generated on the basis of the area. The skill of the operator Ma is evaluated to be higher as the area is smaller, and the skill of the operator Ma is evaluated to be lower as the area is larger.

In addition, in the present embodiment, the movement start position SP and the movement end position EP are located on the basis of the imaging data. The detected data acquisition unit 601 acquires the distance between the movement start position SP and the movement end position EP on the basis of the imaging data. In the present embodiment, the detected data acquired by the detected data acquisition unit 601 include the movement distance of the bucket 13 between the movement start position SP and the movement end position EP.

The evaluation data generation unit 604 generates evaluation data on the basis of the distance between the movement start position SP and the movement end position EP. As the distance between the movement start position SP and the movement end position EP is longer, which means that the bucket 13 was able to be moved for a longer distance along the target movement locus, the skill of the operator Ma is evaluated to be higher. As the distance between the movement start position SP and the movement end position EP is shorter, which means that the bucket 13 was able to be moved for a shorter distance along the target movement locus, the skill of the operator Ma is evaluated to be lower.

In addition, in the present embodiment, the time having elapsed from the start of movement of the bucket 13, and the movement time of the bucket 13 from the movement start position SP to the movement end position EP are acquired on the basis of the imaging data. The detected data acquisition unit 601 includes an internal timer. The detected data acquisition unit 601 acquires the times at the movement start time point and the movement end time point of the bucket 13 on the basis of the result of measurement of the internal timer and the imaging data from the imager 63. In the present embodiment, the detected data acquired by the detected data acquisition unit 601 include the movement time of the bucket 13 between the movement start time point SP and the movement end time point.

The evaluation data generation unit 604 generates evaluation data on the basis of the movement time of the bucket 13 between the movement start time point and the movement end time point. As the time between the movement start time point and the movement end time point is shorter, which means that the bucket 13 was able to be moved in a shorter time along the target movement locus, the skill of the operator Ma is evaluated to be higher. As the time between the movement start time point and the movement end time point is longer, which means that a longer time was taken to move the bucket 13 along the target movement locus, the skill of the operator Ma is evaluated to be lower.

In addition, as described above, the detected data acquisition unit 601 calculates the actual movement distance of the bucket 13 from the movement start position SP to the movement end position EP. Thus, the detected data acquisition unit 601 can calculate the moving speed (average moving speed) of the bucket 13 between the movement start position SP and the movement end position EP on the basis of the actual movement distance of the bucket 13 from the movement start position SP to the movement end position EP and the movement time of the bucket 13 from the movement start time point to the movement end time point. In the present embodiment, the detected data acquired by the detected data acquisition unit 601 include the moving speed of the bucket 13 between the movement start position SP and the movement end position EP.

The evaluation data generation unit 604 generates evaluation data on the basis of the moving speed of the bucket 13 between the movement start position SP and the movement end position EP. As the moving speed of the bucket 13 between the movement start position SP and the movement end position EP is higher, which means that the bucket 13 was able to be moved at a higher speed along the target movement locus, the skill of the operator Ma is evaluated to be higher. Ass the moving speed of the bucket 13 between the movement start position SP and the movement end position EP is lower, which means that the bucket 13 was able to be moved at a lower speed along the target movement locus, the skill of the operator Ma is evaluated to be lower.

After the evaluation data are generated, a process of displaying the evaluation data on the display device 64 is performed (step S360). The display control unit 605 generates display data from the evaluation data, and displays the display data on the display device 64.

The display control unit 605 displays the name of the operator Ma, which is personal data, on the display device 64. The display control unit 605 also displays, as the evaluation data, items of “linearity” indicating the difference between the target movement locus and the detected movement locus, “distance” indicating the movement distance of the bucket 13 from the movement start position SP to the movement end position EP, “time” indicating the movement time of the bucket 13 from the movement start position SP to the movement end position EP, and “speed” indicating the average moving speed of the bucket 13 from the movement start position SP to the movement end position EP on the display device 64. The display control unit 605 also displays numerical value data of the respective items “linearity,” “distance,” “time,” and “speed” on the display device 64. The display control unit 605 also displays a score of the skill of the operator Ma on the display device 64. The storage unit 608 stores reference data about the skill. The reference data are evaluation data of operators having a standard skill, which are obtained statistically or empirically, for example. The score of the skill of the operator Ma is calculated on the basis of the reference data.

In the present embodiment, the evaluation data generation unit 604 outputs the generated evaluation data to an external server via the communication device 67. The external server may be the management device 4, the work vehicle data collection device 5, or a server other than the management device 4 and the work vehicle data collection device 5.

After the evaluation data are transmitted to the external server, relative data representing evaluation of the operator Ma relative to other operators Ma are supplied from the external server to the communication device 67 of the portable device 6. The relative data acquisition unit 615 acquires the relative data supplied from the external server. The display control unit 605 generates display data from the relative data, and displays the display data on the display device 64.

In the present embodiment, the relative data representing evaluation of the operator Ma relative to other operators Ma include ranking data of the skills of a plurality of operators Ma. The evaluation data of a plurality of operators Ma present all over the country are transmitted to the external server. The external server aggregates and analyzes the evaluation data of each of the plurality of operators Ma, and generates ranking data of the skills of each of the plurality of operators Ma. The external server distributes the generated ranking data to each of a plurality of portable devices 6.

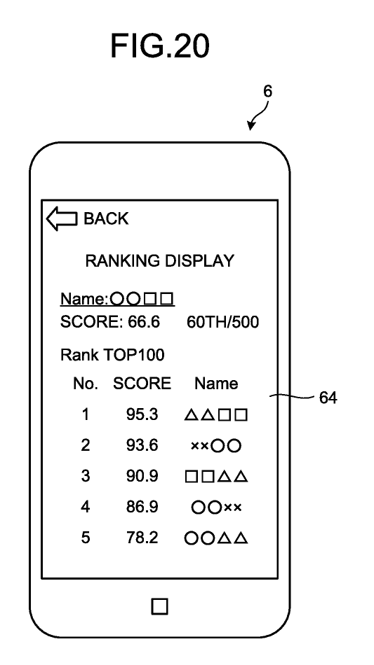

FIG. 20 is a diagram for explaining an example of a method for displaying the relative data according to the present embodiment. As illustrated in FIG. 20, the display control unit 605 generates display data from the relative data, and displays the display data on the display device 64. In the example illustrated in FIG. 20, the display control unit 605 displays, on the display device 64, the name of the operator Ma, the number of the plurality of operators Ma all over the country whose personal data are registered with portable devices 6 and whose evaluation data are generated with the portable device 6, the ranking of the skills of the operators Ma whose evaluation data are generated with the portable device 6 among the plurality of operators Ma all over the country, and an evaluation score representing the evaluation data.

### Link Data Output

Next, output of the link data illustrated in FIG. 8 (step S400) will be described. The link processing unit 606 generates link data associating evaluation data of the operator Ma with position data of the portable device 6 having the imager 63. The absolute position of the imager 63 and the absolute position of the operator Ma evaluated on the basis of movement data obtained by imaging by the imager 63 are substantially the same. The position data of the imager 63 are detected by the position detector 62 (GNSS). Specifically, the link processing unit 606 generates link data associating the place at which the work machine 10 operated by the operator Ma is imaged with the evaluation data of the operator Ma.

In the present embodiment, the link data include the evaluation data of the operator Ma, the personal data of the operator Ma, the relative data of the operator Ma, and the position data of the imager 63 representing the imaging place at which the evaluation of the operator Ma is performed. The link processing unit 606 generates link data associating the evaluation data of the operator Ma, the personal data of the operator Ma, the relative data of the operator Ma, and the position data of the imager 63.

The link data output unit 607 outputs the link data generated by the link processing unit 606 to the management device 4 via the communication device 67.

### Map Data Generation

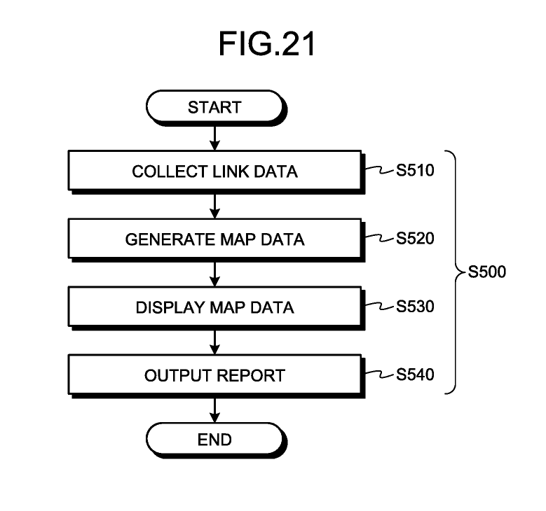

Next, map data generation illustrated in FIG. 8 (step S500) will be described. FIG. 21 is a flowchart illustrating an example of a map data method according to the present embodiment. In the present embodiment, the map data generation method includes a step (S510) of collecting link data of each of a plurality of operators Ma, a step (S520) of generating map data from a plurality of pieces of the collected link data, a step (S530) of displaying the map data on the display device 42, and a step (S540) of outputting a report on the basis of the plurality of pieces of collected link data.

The link data of operators Ma are transmitted from a plurality of portable devices 6 present all over the country to the management device 4. The link data acquisition unit 401 of the management device 4 collects the link data for each of a plurality of operators Ma via the communication device 45 (step S510).

The map data generation unit 402 of the management device 4 aggregates and analyzes the acquired link data of the plurality of operators Ma. The map data generation unit 402 extracts the positions of the plurality of operator Ma from the plurality of pieces of collected link data to generate map data of the operators Ma (step S520).

The link data include not only position data of the operator Ma (the position data of the imager 63) but also the evaluation data of the operator Ma, the personal data of the operator Ma, and the relative data of the operator Ma. The arithmetic processor 40 maps the locations of the operators Ma, the personal data of the operators Ma, the relative data of the operators Ma, and the skills of the operators Ma on the basis of the acquired link data.

The arithmetic processor 40 generates display data from the generated map data, and displays the display data on the display device 42 of the management device 4 (step S530).

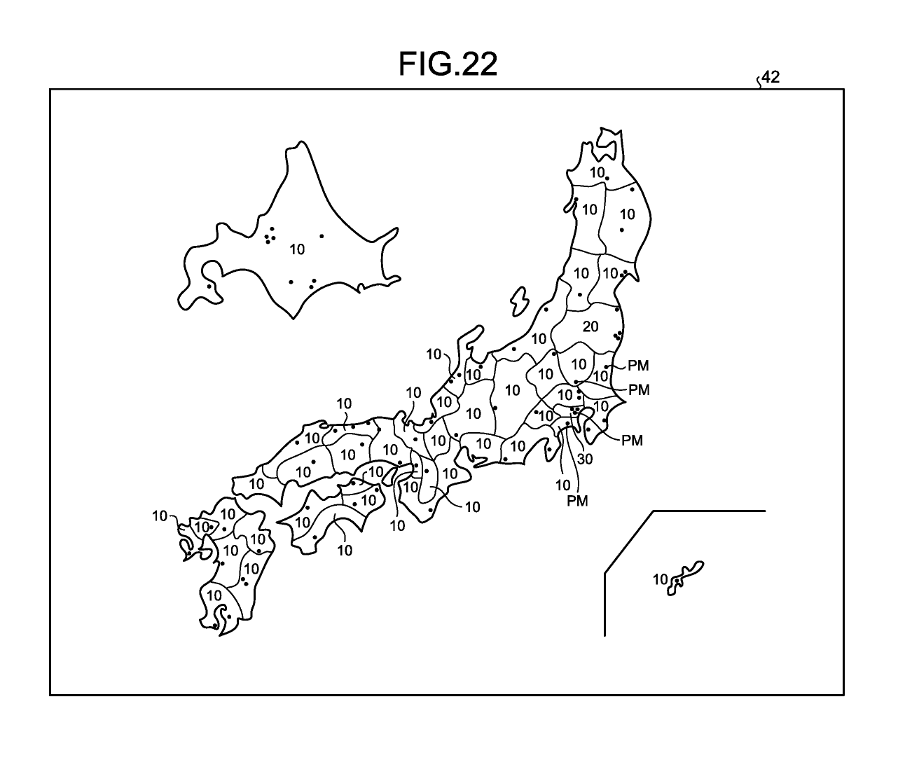

FIG. 22 is a diagram schematically illustrating an example of the map data displayed on the display device according to the present embodiment. As illustrated in FIG. 22, the arithmetic processor 40 displays a map of the whole country and plots PM representing the locations of the operators Ma on the display device 42. The arithmetic processor 40 also displays the number of operators Ma present in each of the prefectures on the display device 42. Alternatively, plots PM representing the locations of the operators Ma within a predetermined region and the number of operators Ma present within the predetermined region may be displayed by display limited to the predetermined region instead of display in wide area by the map of the whole country.

A plot PM is selected through the input device 43, and the evaluation data of the corresponding operator Ma are then displayed on the display device 42. For example, in a case where the input device 43 includes a mouse, the mouse is clicked with a pointer positioned on a plot PM on the display device 42, and the evaluation data are then displayed on the display device 42. In a case where the input device 43 includes a touch sensor provided on the display screen of the display device 42 and the display device 42 includes a touch panel, a plot PM is tapped on the display device 42, and the evaluation data are then displayed on the display device 42.

In addition, in the present embodiment, a plot PM is selected through the input device 43, and the personal data and the relative data of the corresponding operator Ma are then displayed.

In the present embodiment, the management device 4 is capable of performing data communication with the work vehicle data collection device 5. The work vehicle data indicating the location and the use state of each of the plurality of excavators 3 present all over the country are transmitted from the excavator 3 to the work vehicle data collection device 5. The excavators 3 that transmit the work vehicle data to the work vehicle data collection device 5 include the excavator 3 used in generation of the evaluation data of the operator Ma.

The position of the excavator 3 is detected by the position detector 33 (GNSS). The use state of the excavator 3 includes a working mode of the work machine 10, the moving speed of the work machine 10, a traveling mode of the lower traveling structure 22, the traveling speed of the lower traveling structure 22, the fuel consumption of the excavator 3, an average operating time per day, and the like, for example. The sensor system 32 of the excavator 3 includes a plurality of sensors capable of detecting these use states. The arithmetic processor 30 of the excavator 3 transmits the work vehicle data including the position of the excavator 3 detected by using the position detector 33 and the use state of the excavator 3 detected by using the sensor system 32 to the work vehicle data collection device 5 via the communication device 35.

The work vehicle data collection device 5 acquires the work vehicle data of a plurality of excavators 3 via the communication device 53. The work vehicle data collection device 5 aggregates and analyzes the plurality of pieces of the acquired work vehicle data of the excavators 3.

The work vehicle data collection device 5 transmits the work vehicle data of the plurality of excavators 3 present all over the country to the management device 4 via the communication device 53.

The map data generation unit 402 of the management device 4 extracts the positions and the use states of the excavators 3 from the work vehicle data transmitted from the work vehicle data collection device 5 to generate map data of the excavators 3. The map data include the use state data of the excavators 3. The map data generation unit 402 maps the locations and the use states of the excavators 3 on the basis of the acquired work vehicle data.

The display control unit 405 generates display data from the map data generated by the map data generation unit 402, and displays the display data on the display device 42 of the management device 4.

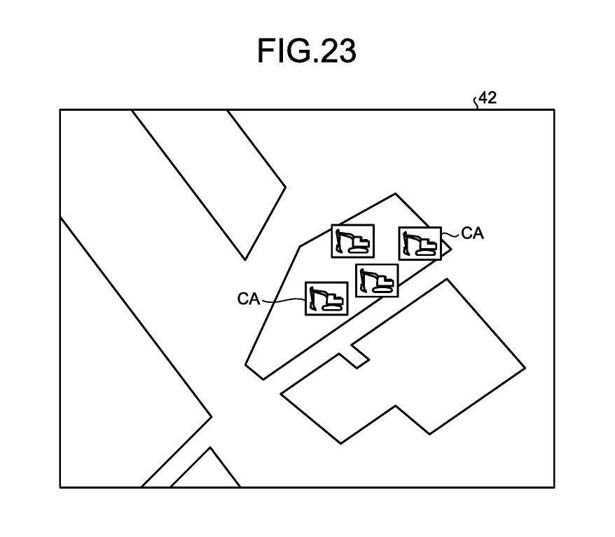

FIG. 23 is a diagram schematically illustrating an example of the map data displayed on the display device 42 according to the present embodiment. As illustrated in FIG. 23, the display control unit 405 displays a map on the display device 42, and also displays icons CA at positions on the map corresponding to the positions (locations) of the excavators 3. Pictures representing the excavators 3 are used for the icons CA, for example.

An icon CA is selected through the input device 43, and the use state data of the corresponding excavator 3 are then displayed on the display device 42. For example, in a case where the input device 43 includes a mouse, the mouse is clicked with a pointer positioned on an icon CA on the display device 42, and the use state data of the excavator 3 are then displayed on the display device 42. In a case where the input device 43 includes a touch sensor provided on the display screen of the display device 42 and the display device 42 includes a touch panel, an icon CA is tapped on the display device 42, and the use state data of the excavator 3 are then displayed on the display device 42.

The link data of the operator Ma are transmitted together with time data representing the time point Ta at which the link data are generated to the management device 4 from the portable device 6. In addition, the work vehicle data of the excavator 3 are transmitted at regular time intervals to the work vehicle data collection device 5 from the excavator 3. The link data of the operator Ma includes the position data of the imager 63. The work vehicle data of the excavator 3 includes the position data of the excavator 3.

The position of an imager 63, the position of the operator Ma evaluated on the basis of the movement data of the excavator 3 acquired by the imager 63, and the position of the excavator 3 operated by the operator Ma can be deemed to be substantially the same. Thus, the link data acquisition unit 401 is capable of locating the excavator 3 having been present at a position substantially the same as that of the imager 63 at a time point Ta, at which the link data have been generated, on the basis of the time point Ta and the position data of the excavator 3 output at regular time intervals.

Thus, the link data acquisition unit 401 is capable of associating the excavator 3 operated by the operator Ma at the time point Ta with the imager 63 having acquired the movement data of the work machine 10 of the excavator 3 on the basis of the position data of the imager 63 extracted from the link data, time data representing the time point Ta at which the link data are generated, and the position data of the excavator 3 extracted from the work vehicle data output at regular time intervals. Thus, the link data acquisition unit 401 is capable of identifying which imager 63 has acquired movement data of an excavator 3 and identifying the movement data of which excavator 3 the imager 63 has acquired among a plurality of imagers 63 and a plurality of excavators 3 present all over the country.

The link data acquisition unit 401 is also capable of extracting the use state data of an excavator 3 from the work vehicle data of the excavator 3 supplied from the work vehicle data collection device 5, and obtaining in what use state the excavator 3 used for evaluation of the operator Ma was used.

The map data generation unit 402 extracts the position and the use state of each excavator 3 from work vehicle data, and generates map data of excavators 3. The map data generation unit 402 is capable of generating map data indicating. the skill level of an operator Ma present at a certain location, the location of the excavator 3 operated by the operator Ma, and the use state of the excavator 3 among a plurality of operators Ma and a plurality of excavators 3 present all over the country.

For example, the fuel efficiency of an excavator 3 operated by a less skilled operator Ma is likely to be lower than that of an excavator 3 operated by a more skilled operator Ma. In addition, the average operation time per day of an excavator 3 operated by a less skilled operator Ma is likely to be longer than that of an excavator 3 operated by a more skilled operator Ma. In other words, the use state of the excavator 3 is likely to change depending on the skill of the operator Ma.

The map data generation unit 402 associates the location and the evaluation data of an operator Ma with the location and the use state data of an excavator 3. Alternatively, the map data generation unit 402 may associate the location and the evaluation data of an operator Ma with the location of an excavator 3. The association of the location and the evaluation data of an operator Ma with the location and the use state data of an excavator 3 shows the skill levels of operators Ma present at a construction site, and the use states and the locations of excavators 3, which are beneficial to education such as right instruction of operation depending on the skill of the operator Ma, and proposal for an excavator 3 optimum for construction (a computerized construction machine, for example). Alternatively, the map data generation unit 402 outputs a report provided for education of an operator Ma, proposal for an excavator 3 optimum for construction (step S540). Association of the locations and the evaluation data of the operators Ma with the locations of the excavators 3 allows vendors or rental dealers of work vehicles to efficiently carry out sales activities of excavators 3 for customers. For example, in determining the order in which customers are to be visited, priorities can be given to visit to the locations of operators Ma with poor skill, or the order of visits can be determined so that traveling for making rounds to destinations will be efficient.

### Operations and Effects

As described above, according to the present embodiment, the evaluation device 600 includes the detected data acquisition unit 601 to acquire detected data of the work machine 10 on the basis of the movement data of the work machine 10 imaged by the imager 63, the evaluation data generation unit 604 to generate the evaluation data of the operator Ma on the basis of the detected data, the position data acquisition unit 614 to acquire the position data of the imager 63, the link processing unit 606 to generate link data associating the evaluation data of the operator Ma with the position data of the imager 63, and the link data output unit 607 to output the link data. This allows the skill of an operator Ma of the excavator 3 and the location of the operator Ma to be efficiently obtained. Thus, vendors that sell the excavators 3 for crawler tracks or rental dealers that rent the excavators 3 for crawler tracks can effectively use the link data so as to make appropriate proposals for crawler tracks, appropriately make rounds to destinations, and the like, and efficiently carry out sales activities.

In addition, according to the present embodiment, the evaluation device 600 includes the input data acquisition unit 611 to acquire the input data including the personal data of the operator Ma generated by operation of the input device 65. The link data include the evaluation data of the operator Ma, the position data of the imager 63, and the personal data of the operator Ma. Since the personal data are included in the link data, the conditions of crawler tracks can be obtained in more detail, vendors or rental dealers can further make more appropriate proposals for crawler tracks, and more efficiently carry out sales activities.

In addition, according to the present embodiment, the personal data include at least one of the sex, the age, and the number of years of experience of driving the work vehicle of the operator Ma. This allows vendors or rental dealers to obtain the conditions of the crawler tracks in more detail.

In addition, according to the present embodiment, the evaluation device 600 incudes the input determination unit 612 to determine whether or not required data, which are prescribed input data, have been input, and the restriction unit 613 to restrict the operation of the imager when the required data are determined not to have been input. As a result, since extensive link data are generated on the basis of only the operator Ma whose required data have been input, vendors or rental dealers can effectively use the link data to efficiently carry out sales activities.

In addition, according to the present embodiment, the evaluation device 600 includes the relative data acquisition unit 615 to acquire relative data representing evaluation of an operator Ma relative to other operators Ma after the link data are output from the link data output unit 607, and the display control unit 605 to generate display data from the relative data and displays the display data on the display device 64. Since the relative data including the ranking data of the operators Ma all over the country participating in the evaluation are displayed on the display device 64, an operator Ma can objectively know his/her skill. Provision of the relative data improves the motivation of the operator Ma for skill improvement.

In addition, according to the present embodiment, the display control unit 605 generates display data from the evaluation data, and displays the display data on the display device 64. This allows the operator Ma to visually recognize the evaluation data of his/her skill.

In addition, according to the present embodiment, the management device 4 includes the link data acquisition unit 401 to acquire link data associating the evaluation data of an operator Ma with the position data of a detector 63, and the map data generation unit 402 to extract the positions of the operators Ma from link data to generate map data of the operators Ma. This allows the skill of an operator Ma and the location of the operator Ma having the skill to be quickly obtained. Thus, the vendors or rental dealers of the excavators 3 can efficiently carry out sales activities.

In addition, according to the present embodiment, the map data generation unit 402 also maps the evaluation data of the operator Ma. This allows the skill levels of operators Ma and the locations of the operators Ma to be easily obtained.

In addition, according to the present embodiment, the management device 4 includes the display control unit 403 to generate display data from the map data, and display the display data on the display device 42. This allows the vendors or the rental dealers of the excavators 3 to visually recognize the skills of the operators Ma and the locations of the operators Ma having the skills.

In addition, according to the present embodiment, the management device 4 includes the work vehicle data acquisition unit 404 to acquire work vehicle data representing the position and the use state of an excavator 3 imaged by an imager 63. The map data generation unit 402 extracts the position and the use state of each excavator 3 from work vehicle data, and generates map data of excavators 3. This allows the use state of each excavator 3 and the locations of the excavators 3 used in the use state to be easily obtained. Furthermore, in usual construction, the skill level of the operator Ma operating an excavator 3 can be obtained. Thus, vendors or rental dealers of the excavators 3 are capable of appropriately providing education of operation instruction of an excavator 3 and making proposal for an excavator 3 optimum for construction on the basis of the map data of the excavators 3, and thus efficiently carrying out sales activities.

### Other Embodiments

Note that, in the embodiment described above, some or all of the functions of the evaluation device 600 of the portable device 6 may be included in the evaluation device 400 of the management device 4. The movement data of the excavator 3 detected by the detector 63 are transmitted to the management device 4 via the communication device 67, which allows the management device 4 to evaluate the skill of the operator Ma on the basis of the movement data of the excavator 3. Since the management device 4 includes the arithmetic processor 40 and the storage device 41 capable of storing computer programs for carrying out the evaluation method according to the present embodiment, the management device 4 can achieve the functions of the evaluation device 600.

Note that, in the embodiment described above, some or all of the functions of the evaluation device 400 of the management device 4 may be included in the evaluation device 600 of the portable device 6. The evaluation device 600 of the portable device 6 may generate link data on the basis of the movement data of the excavator 3 detected by the detector 63, and generate map data from the link data. In addition, the work vehicle data of the excavator 3 may be transmitted to the portable device 6, and the evaluation device 600 of the portable device 6 may extract the positions and the use states of the plurality of excavators 3 from the plurality of pieces of work vehicle data to generate map data of the excavators 3.

Note that, in the embodiment described above, in generation of link data associating the place at which the work machine 10 operated by an operator Ma has been imaged with the evaluation data of the operator Ma, the link data associating the evaluation data of the operator Ma with the position data of the imager 63 are generated. In a case where a position detector such as a GNSS receiver to detect the position of an excavator 3 in a global coordinate system is mounted on the excavator 3, link data associating the position data of the excavator 3 detected by the position detector with the evaluation data of the operator Ma may be generated. In this case, the evaluation data of the operator Ma are transmitted from the portable device 6 to the management device 4, and the position data of the excavator 3 are transmitted from the excavator 3 to the management device 4. Identification data for identifying the excavator 3 imaged by the imager 63 are added to the evaluation data of the operator Ma to be transmitted from the portable device 6 to the management device 4, and identification data for identifying the excavator 3 are given to the position data of the excavator 3 to be transmitted from the excavator 3 to the management device 4, which allows the management device 4 to generate link data associating the place at which the work machine 10 operated by the operator Ma has been imaged with the evaluation data of the operator Ma on the basis of the evaluation data of the operator Ma transmitted from the portable device 6 and the position data of the excavator 3 transmitted from the excavator 3.

Note that, in the embodiment described above, the skill of an operator Ma is evaluated on the basis of the movement data of the work machine 10. Alternatively, the operating state of the work machine 10 may be evaluated on the basis of the movement data of the work machine 10. For example, an inspection process of determining whether or not the operation state of the work machine 10 is normal or not may be performed on the basis of the movement data of the work machine 10.

Note that, in the embodiment described above, the work vehicle 3 is an excavator 3. The work vehicle 3 may be any work vehicle having a work machine movable relative to the vehicle body such as a bulldozer, a wheel loader, or a forklift.

### REFERENCE SIGNS LIST

1 EVALUATION SYSTEM

2 CONSTRUCTION SITE

3 EXCAVATOR (WORK VEHICLE)

3C EXCAVATOR (WORK VEHICLE)

4 MANAGEMENT DEVICE (FIRST SERVER)

5 WORK VEHICLE DATA COLLECTION DEVICE (SECOND SERVER)

6 PORTABLE DEVICE

7 OPERATOR'S SEAT

8 OPERATING DEVICE

8WR RIGHT WORKING LEVER

8WL LEFT WORKING LEVER

8MR RIGHT TRAVELING LEVER

8ML LEFT TRAVELING LEVER

10 WORK MACHINE

11 BOOM

11P BOOM PIN

12 ARM

12P ARM PIN

13 BUCKET

13B BLADE EDGE

13P BUCKET PIN

14 BOOM CYLINDER

15 ARM CYLINDER

16 BUCKET CYLINDER

20 VEHICLE BODY

21 UPPER SWING STRUCTURE

22 LOWER TRAVELING STRUCTURE

23 CAB

24 COUNTER WEIGHT

25 DRIVE WHEEL

26 IDLER WHEEL

27 CRAWLER TRACK

30 ARITHMETIC PROCESSOR

31 STORAGE DEVICE

32 SENSOR SYSTEM

33 POSITION DETECTOR

34 INPUT/OUTPUT INTERFACE DEVICE

35 COMMUNICATION DEVICE

40 ARITHMETIC PROCESSOR

41 STORAGE DEVICE

42 OUTPUT DEVICE

43 INPUT DEVICE

44 INPUT/OUTPUT INTERFACE DEVICE

45 COMMUNICATION DEVICE

50 ARITHMETIC PROCESSOR

51 STORAGE DEVICE

52 INPUT/OUTPUT INTERFACE DEVICE

53 COMMUNICATION DEVICE

60 ARITHMETIC PROCESSOR (EVALUATION DEVICE)

61 STORAGE DEVICE

62 POSITION DETECTOR

63 IMAGER

63C DETECTOR

64 DISPLAY DEVICE

65 INPUT DEVICE

66 INPUT/OUTPUT INTERFACE DEVICE

67 COMMUNICATION DEVICE

70 GUIDE LINE

400 EVALUATION DEVICE

401 LINK DATA ACQUISITION UNIT

402 MAP DATA GENERATION UNIT

403 WORK VEHICLE DATA ACQUISITION UNIT

404 DISPLAY CONTROL UNIT

600 EVALUATION DEVICE

601 DETECTED DATA ACQUISITION UNIT

602 POSITION DATA CALCULATION UNIT

603 TARGET DATA GENERATION UNIT

604 EVALUATION DATA GENERATION UNIT

605 DISPLAY CONTROL UNIT

606 LINK PROCESSING UNIT

607 LINK DATA OUTPUT UNIT

608 STORAGE UNIT

611 INPUT DATA ACQUISITION UNIT

612 INPUT DETERMINATION UNIT

613 RESTRICTION UNIT

614 POSITION DATA ACQUISITION UNIT

615 RELATIVE DATA ACQUISITION UNIT

1000 REMOTE CONTROL ROOM

1100 CONSTRUCTION INFORMATION DISPLAY DEVICE

1200 OPERATOR'S SEAT

1300 OPERATING DEVICE

1310R RIGHT WORKING LEVER

1310L LEFT WORKING LEVER

1320R RIGHT TRAVELING LEVER

1320L LEFT TRAVELING LEVER

2000 PORTABLE TERMINAL DEVICE

AX1 ROTATION AXIS

AX2 ROTATION AXIS

AX3 ROTATION AXIS

CA ICON

CB ICON

DX1 ROTATION AXIS

DX2 ROTATION AXIS

EP MOVEMENT END POSITION

MA OPERATOR

MB WORKER

MD TEXT DATA

PD PLOT

PM PLOT

RL TARGET LINE

RX SWING AXIS

SP MOVEMENT START POSITION

TD ELAPSED TIME DATA

TL DETECTED LINE

1. An evaluation device comprising:
a detected data acquisition unit configured to acquire detected data including a moving state of a work machine of a work vehicle operated by an operator through an operating device on the basis of movement data obtained by detecting operation of the work machine by a detector;
an evaluation data generation unit configured to generate evaluation data of the operator on the basis of the detected data;
a position data acquisition unit configured to acquire position data of the detector;
a link processing unit configured to generate link data associating the evaluation data with the position data; and
a link data output unit configured to output the link data.

2. The evaluation device according to claim 1, comprising:
an input data acquisition unit configured to acquire input data generated by operation of an input device, wherein
the input data includes personal data of the operator, and
the link processing unit generates the link data associating the evaluation data, the position data, and the personal data with one another.

3. The evaluation device according to claim 2, wherein
the personal data include at least one of sex, age, and the number of years of experience of driving the work vehicle of the operator.

4. The evaluation device according to claim 2, comprising:
an input determination unit configured to determine whether or not required data representing prescribed input data have been input; and
a restriction unit configured to restrict operation of the detector when the required data are determined not to have been input.

5. A management device comprising:
a link data acquisition unit configured to acquire link data associating evaluation data of an operator generated on the basis of movement data, the movement data being obtained by detecting operation of a work machine of a work vehicle operated by the operator through an operating device by a detector, with position data of the detector; and
a map data generation unit configured to extract a position of the operator from the link data to generate map data of the operator.

6. The management device according to claim 5, wherein the map data include evaluation data of the operator.

7. The management device according to claim 5, comprising:
a work vehicle data acquisition unit configured to acquire work vehicle data representing a position and a use state of the work vehicle detected by the detector, wherein
the map data generation unit extracts the position and the use state of the work vehicle from the work vehicle data to generate map data of the work vehicle.

8. An evaluation system comprising:
a detected data acquisition unit configured to acquire detected data including a moving state of a work machine of a work vehicle operated by an operator through an operating device on the basis of movement data obtained by detecting operation of the work machine by a detector;
an evaluation data generation unit configured to generate evaluation data of the operator on the basis of the detected data;
a position data acquisition unit configured to acquire position data of the detector;
a link processing unit configured to generate link data associating the evaluation data with the position data; and
a link data acquisition unit configured to collect the link data of each of a plurality of operators.

9. The evaluation system according to claim 8, comprising:
a map data generation unit configured to generate map data of the operator by extracting positions of the plurality of operators from a plurality of pieces of the link data.

10. The evaluation system according to claim 9, wherein the map data include evaluation data of the operators.

11. The evaluation system according to claim 8, comprising:
a work vehicle data acquisition unit configured to acquire work vehicle data representing a position and a use state of the work vehicle having the work machine operated by the operator, wherein
the map data generation unit generates map data of a plurality of work vehicles by extracting the positions and the use states of the work vehicles from a plurality of pieces of the work vehicle data.

12. The evaluation system according to claim 9, wherein the link data include personal data of the operator.

13. An evaluation method comprising:
acquiring detected data including a moving state of a work machine of a work vehicle operated by an operator through an operating device on the basis of movement data obtained by detecting operation of the work machine by a detector;
generating evaluation data of the operator on the basis of the detected data;
acquiring position data of the detector;
generating link data associating the evaluation data with the position data; and
collecting the link data of each of a plurality of operators.

14. The evaluation system according to claim 11, wherein the link data include personal data of the operator.
